(19) United States
(12) Patent Application Publication
(10) Pub. No.: US 2026/0133588 A1
(43) Pub. Date: May 14, 2026

(54) METHODS, APPARATUSES, AND ELECTRONIC DEVICES FOR DISPATCHING UNMANNED VEHICLE FLEETS

(71) Applicant: ZHEJIANG SIQIAN AUTONOMOUS DRIVING TECHNOLOGY CO., LTD., Huzhou (CN)

(72) Inventors: Bei HE, Huzhou (CN); Yi LIU, Beijing (CN); Na ZHANG, Huzhou (CN); Heyun LIU, Beijing (CN)

(73) Assignee: ZHEJIANG SIQIAN AUTONOMOUS DRIVING TECHNOLOGY CO., LTD., Huzhou (CN)

(21) Appl. No.: 19/441,928

(22) Filed: Jan. 7, 2026

Related U.S. Application Data
(63) Continuation-in-part of application No. PCT/CN2024/106559, filed on Jul. 19, 2024.

(30) Foreign Application Priority Data
Jul. 21, 2023 (CN) 202310898730.7

(51) Int. Cl. G05D 1/644; G05D 1/698

(52) U.S. Cl. CPC G05D 1/644; G05D 1/698

(57) ABSTRACT

Methods, apparatuses, and electronic devices for dispatching an unmanned vehicle fleet are provided. The method includes: acquiring a global path planning result by performing global path planning on the unmanned vehicle fleet in a target area, the global path planning result including a global task path of a task vehicle in the unmanned vehicle fleet; determining a local task path of the task vehicle based on driving information corresponding to the task vehicle and reference information corresponding to the global task path; and generating optimized local task path information by optimizing the local task path based on attribute information of the local task path.

### CROSS-REFERENCE TO RELATED APPLICATIONS

This application is a continuation-in-part of International Patent Application No. PCT/CN2024/106559, filed on Jul. 19, 2024, which claims priority to the Chinese Patent Application No. 202310898730.7, filed on Jul. 21, 2023, and entitled “METHODS, APPARATUSES, AND ELECTRONIC DEVICES FOR DISPATCHING UNMANNED VEHICLE FLEETS,” the contents of which are hereby incorporated by reference.

### TECHNICAL FIELD

The present disclosure generally relates to the field of unmanned driving, and in particular to a method, an apparatus, and an electronic device for dispatching an unmanned vehicle fleet.

### BACKGROUND

With the development of unmanned driving technology, the unmanned vehicle fleet plays an important role in various transportation sites. Taking a port unmanned vehicle fleet as an example, dispatching of the port unmanned vehicle fleet is one of the indispensable modules of a port unmanned transportation system, which performs path planning and behavior control on the port unmanned vehicle fleet to ensure efficient, stable, and safe operation of the entire unmanned transportation system.

In the dispatching of unmanned vehicle fleets, there are generally the following dispatching schemes. First, real-time control is performed on the throttles, brakes, etc., of all vehicles, which not only relies on strong computing power, but also fails to adapt to general port road networks. This scheme is only applicable to fully automated isolated terminals and cannot be promoted to existing ports. In addition, magnetic nails are generally required to be laid to ensure the confirmation of real-time positions, which results in high construction and maintenance costs. Second, independent planning and control are performed on each vehicle, which often causes deadlock due to mutual influence among vehicles. If traffic light assistance and physical isolation are adopted, mixed traffic in the port is further constrained, reducing the operational efficiency of the port. Third, unified path planning and behavior control are performed on the unmanned vehicle fleet, where vehicles are only responsible for positioning and execution, which neither considers local planning of unmanned driving nor considers the influence of external vehicles. Therefore, the unified path planning and behavior control lack intelligent control, cannot cope with mixed-traffic ports, and cannot be promoted as a general solution.

Therefore, it is necessary to provide a method, an apparatus, and an electronic device for dispatching an unmanned vehicle fleet to solve the foregoing technical problems.

### SUMMARY

One or more embodiments of the present disclosure provide a method for dispatching an unmanned vehicle fleet. The method includes: acquiring a global path planning result by performing global path planning on the unmanned vehicle fleet in a target area, wherein the global path planning result includes a global task path of a task vehicle in the unmanned vehicle fleet; determining a local task path of the task vehicle based on driving information corresponding to the task vehicle and reference information corresponding to the global task path; and generating optimized local task path information by optimizing the local task path based on attribute information of the local task path.

In some embodiments, the acquiring a global path planning result by performing global path planning on the unmanned vehicle fleet in a target area includes: in response to a newly added task, determining a newly added vehicle in the unmanned vehicle fleet; determining a starting point and a destination point of the newly added vehicle based on the newly added task; and acquiring the global path planning result by performing the global path planning based on existing task paths of existing task vehicles in the unmanned vehicle fleet and the starting point and the destination point of the newly added vehicle.

In some embodiments, the acquiring a global path planning result by performing global path planning on the unmanned vehicle fleet in a target area includes: constructing a directed road network graph corresponding to the target area, wherein, in the directed road network graph, a node denotes an intersection, an edge denotes a road, and a weight of the edge is related to at least one of a road length or an intersection capacity; and acquiring the global path planning result by performing the global path planning based on the directed road network graph and a starting point and a destination point of the task vehicle.

In some embodiments, the determining a local task path of the task vehicle based on driving information corresponding to the task vehicle and reference information corresponding to the global task path includes: determining a trajectory of the local task path based on obstacle information and traffic rule information; determining a speed of the local task path based on a speed parameter; and determining a length of the local task path based on a safety parameter and the speed parameter.

In some embodiments, the attribute information of the local task path includes at least one of: a trajectory of the local task path, a speed of the local task path, a length of the local task path, a priority of the local task path, or obstacle information corresponding to the local task path.

In some embodiments, the optimizing the local task path based on attribute information of the local task path includes: optimizing the local task path based on the attribute information and an objective function, wherein the objective function is determined based on a similarity between the local task path before optimization and the local task path after optimization and a correlation between different local task paths, and the correlation reflects a collision probability of task vehicles corresponding to the different local task paths.

In some embodiments, the correlation between the different local task paths is determined by: determining a time difference for the task vehicles corresponding to the different local task paths to arrive at a path intersection point based on the attribute information corresponding to the different local task paths; and determining the correlation between the different local task paths based on the time difference.

In some embodiments, the optimized local task path information includes at least one of an optimized local task path or a traffic passing strategy of the task vehicle corresponding to the local task path.

In some embodiments, the method further includes: generating a control instruction based on the optimized local task path information; and driving a steering actuator, a power system, and a braking system of the task vehicle to operate based on the control instruction, so that the task vehicle travels according to the optimized local task path.

In some embodiments, the method further includes: dynamically adjusting the weight of the edge of the directed road network graph based on a historical passing time of the road, a road curvature, or a real-time traffic density, wherein the intersection capacity is determined based on a statistical value of a vehicle flow in the target area, and the vehicle flow is collected by an acquisition device deployed in the target area.

In some embodiments, a speed parameter in the reference information corresponding to the global task path is determined by: determining dynamic characteristics of the task vehicle through a vehicle dynamics model based on a real-time load of the task vehicle, a center-of-gravity position of the task vehicle, a road gradient of the local task path corresponding to the task vehicle, and an adhesion coefficient between a tire and a road surface, wherein the vehicle dynamics model is a machine learning model; determining a maximum recommended speed based on the dynamic characteristics; determining a maximum allowable speed based on a maximum road speed limit, a historical maximum road speed, a maximum safe speed corresponding to a task/vehicle type, a system limit speed of the task vehicle, and the maximum recommended speed; and limiting the speed of the local task path to not exceed the maximum allowable speed.

In some embodiments, the method further includes: generating a speed limiting instruction based on the maximum allowable speed; controlling a speed limiter of the task vehicle to operate based on the speed limiting instruction; and in response to a real-time speed of the task vehicle exceeding the maximum allowable speed, reducing the real-time speed of the task vehicle by the speed limiter.

In some embodiments, the method further includes: determining the similarity between the local task path before optimization and the local task path after optimization based on at least one of a speed deviation, a curvature deviation, or a path offset distance between the local task path before optimization and the local task path after optimization; and adjusting the correlation between the different local task paths based on a road width of the local task path or size information of the task vehicle.

In some embodiments, a numerical value corresponding to the size information of the task vehicle is a dynamic value, and the size information is determined based on a dynamic swept area generated based on a current steering angle and a current articulation angle of the task vehicle.

In some embodiments, the correlation between the different local task paths is positively correlated with an occlusion degree of perception fields of view between the task vehicles.

One or more embodiments of the present disclosure further provide an apparatus for dispatching an unmanned vehicle fleet. The apparatus includes: a global planning module configured to acquire a global path planning result by performing global path planning on the unmanned vehicle fleet in a target area, wherein the global path planning result includes a global task path of a task vehicle in the unmanned vehicle fleet; a local planning module configured to determine a local task path of the task vehicle based on driving information corresponding to the task vehicle and reference information corresponding to the global task path; and an optimization module configured to generate optimized local task path information by optimizing the local task path based on attribute information of the local task path.

One or more embodiments of the present disclosure further provide an electronic device. The electronic device includes: a processor, a memory, and a bus, wherein the memory stores machine-readable instructions executable by the processor, and when the electronic device runs, the processor communicates with the memory through the bus, and the machine-readable instructions, when executed by the processor, cause the processor to perform a method for dispatching an unmanned vehicle fleet, wherein the method comprising: acquiring a global path planning result by performing global path planning on the unmanned vehicle fleet in a target area, wherein the global path planning result includes a global task path of a task vehicle in the unmanned vehicle fleet; determining a local task path of the task vehicle based on driving information corresponding to the task vehicle and reference information corresponding to the global task path; and generating optimized local task path information by optimizing the local task path based on attribute information of the local task path.

### BRIEF DESCRIPTION OF THE DRAWINGS

To more clearly illustrate the technical solutions in the embodiments of the present disclosure, the drawings used in the embodiments are briefly introduced below. It should be understood that the following drawings only show some embodiments of the present disclosure and therefore should not be considered as limiting the scope. For a person of ordinary skill in the art, other related drawings may be obtained based on these drawings without creative efforts.

FIG. 1 is a flowchart illustrating an exemplary process for dispatching an unmanned vehicle fleet according to some embodiments of the present disclosure;

FIG. 2 is a flowchart illustrating an exemplary process for performing global path planning on an unmanned vehicle fleet in a target area according to some embodiments of the present disclosure;

FIG. 3 is a schematic diagram illustrating a global path planning result according to some embodiments of the present disclosure;

FIG. 4 is a flowchart illustrating an exemplary process for performing local path planning on a task vehicle according to some embodiments of the present disclosure;

FIG. 5 is a schematic diagram illustrating a local path planning result according to some embodiments of the present disclosure;

FIG. 6 is a schematic diagram illustrating local task paths of task vehicles according to some embodiments of the present disclosure;

FIG. 7 is a flowchart illustrating an exemplary process for optimizing a local task path according to some embodiments of the present disclosure;

FIG. 8 is a schematic diagram illustrating a time difference for task vehicles corresponding to different local task paths to arrive at a path intersection point according to some embodiments of the present disclosure;

FIG. 9 is a schematic diagram illustrating an exemplary optimization process of a local task path according to some embodiments of the present disclosure;

FIG. 10 is another schematic diagram illustrating an exemplary optimization process of a local task path according to some embodiments of the present disclosure;

FIG. 11 is another schematic diagram illustrating an exemplary optimization process of a local task path according to some embodiments of the present disclosure;

FIG. 12 is another schematic diagram illustrating an exemplary optimization process of a local task path according to some embodiments of the present disclosure;

FIG. 13 is a schematic diagram illustrating a structure of an apparatus for dispatching an unmanned vehicle fleet according to some embodiments of the present disclosure; and

FIG. 14 is a schematic diagram illustrating a structure of an electronic device according to some embodiments of the present disclosure.

### DETAILED DESCRIPTION

To make the objectives, technical solutions, and advantages of the embodiments of the present disclosure clearer, the technical solutions in the embodiments of the present disclosure are clearly and completely described below with reference to the accompanying drawings in the embodiments of the present disclosure. It should be understood that the accompanying drawings in the present disclosure are for illustrative and descriptive purposes only and are not intended to limit the scope of protection of the present disclosure. In addition, it should be understood that the schematic accompanying drawings are not drawn to scale. The flowcharts used in the present disclosure illustrate operations implemented according to some embodiments of the present disclosure. It should be understood that the operations of the flowcharts may be implemented out of order. Operations without a logical contextual relationship may be reversed in order or implemented simultaneously. Furthermore, under the guidance of the content of the present disclosure, those skilled in the art may add one or more other operations to the flowchart or remove one or more operations from the flowchart.

In addition, the described embodiments are merely a part of the embodiments of the present disclosure, not all of them. Generally, components of the embodiments of the present disclosure described and illustrated in the accompanying drawings herein may be arranged and designed in various configurations. Therefore, the following detailed description of the embodiments of the present disclosure provided in the accompanying drawings is not intended to limit the scope of the claimed present disclosure but merely represents selected embodiments of the present disclosure. Based on the embodiments of the present disclosure, all other embodiments obtained by those skilled in the art without creative efforts fall within the scope of protection of the present disclosure.

It should be noted that the term “include” is used in the embodiments of the present disclosure to indicate the existence of the subsequently declared features, but does not exclude the addition of other features.

The embodiments of the present disclosure provide a method, an apparatus, and an electronic device for dispatching an unmanned vehicle fleet. The method includes: acquiring a global path planning result by performing global path planning on the unmanned vehicle fleet in a target area, wherein the global path planning result includes a global task path of a task vehicle in the unmanned vehicle fleet; determining a local task path of the task vehicle based on driving information corresponding to the task vehicle and reference information corresponding to the global task path; and generating optimized local task path information by optimizing the local task path based on attribute information of the local task path. According to the method in the embodiments of the present disclosure, unified global path planning can be performed on the unmanned vehicle fleet. Local task path planning can be performed on the unmanned vehicle fleet during driving, and reverse local optimization can be performed by combining real-time driving information of vehicles and comprehensively considering various external factors, which can ensure safety while effectively improving the overall efficiency and dispatching accuracy of the unmanned vehicle fleet. Moreover, no additional installation of traffic lights, isolation devices, etc., is required, so that the method can be promoted and applied to various complex scenarios.

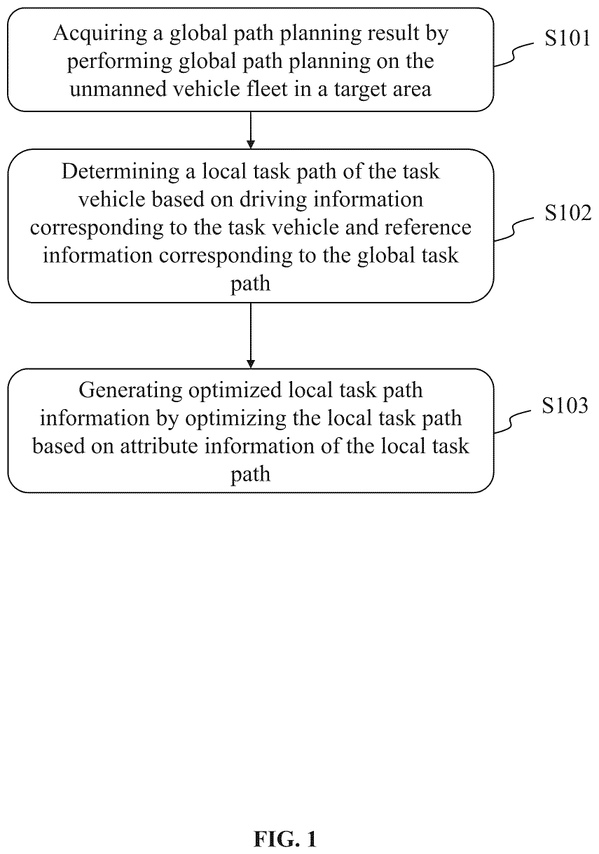

FIG. 1 is a flowchart illustrating an exemplary process for dispatching an unmanned vehicle fleet according to some embodiments of the present disclosure. In some embodiments, a method for dispatching an unmanned vehicle fleet may be executed by a dispatching platform (e.g., a server, a terminal device, a processing device, an electronic device, etc.). The dispatching platform refers to a platform that executes a dispatching task (e.g., publishing operation tasks and control information corresponding to a task vehicle, performing global path planning, etc.).

In S101, a global path planning result is acquired by performing global path planning on an unmanned vehicle fleet in a target area. The global path planning result includes a global task path of a task vehicle in the unmanned vehicle fleet.

The target area refers to a site or an area where the unmanned vehicle fleet performs the operation tasks. For example, the target area may be a port, a dock, a logistics park, a bulk cargo distribution center, etc.

The operation task may be uploaded by a user to the dispatching platform, and the operation task corresponding to each task vehicle of the unmanned vehicle fleet may be the same or different.

The task vehicle refers to a vehicle that performs the operation task. The unmanned vehicle fleet may include a plurality of task vehicles, and the plurality of task vehicles may interact with the dispatching platform. For example, the plurality of task vehicles may receive control information sent by the dispatching platform and perform related operation tasks according to the received control information. As another example, the plurality of task vehicles may collect driving information (e.g., positioning information, obstacle information, etc.) during driving and transmit the driving information to the dispatching platform.

The global path planning refers to planning an overall optimal task path from a starting point to a destination point for the plurality of task vehicles in the unmanned vehicle fleet from an overall perspective. The global path planning result refers to a set of global task paths of the plurality of task vehicles obtained after performing the global path planning.

The global task path of the task vehicle may refer to a globally planned path from the starting point to the destination point. Merely by way of example, the starting point and/or the destination point may include, but are not limited to, a quay crane, a yard crane, a stacker, a buffer zone, a maintenance area, a charging area, a parking lot, or the like. In the embodiments of the present disclosure, selection of the starting point and the destination point is decoupled from the operation task. Merely by way of example, assuming that an operation task is to load a first cargo and a second cargo at a point A, transport the first cargo to a point B, and transport the second cargo to a point C, the dispatching platform may decouple the operation task, use the point A and the point B as a set of the starting point and the destination point, use the point B and the point C as another set of the starting point and the destination point, and perform the corresponding global path planning. Decoupling the starting point and the destination point from the operation task can ensure that the planning of the global path is a minimal atomic operation and is not affected by the operation task.

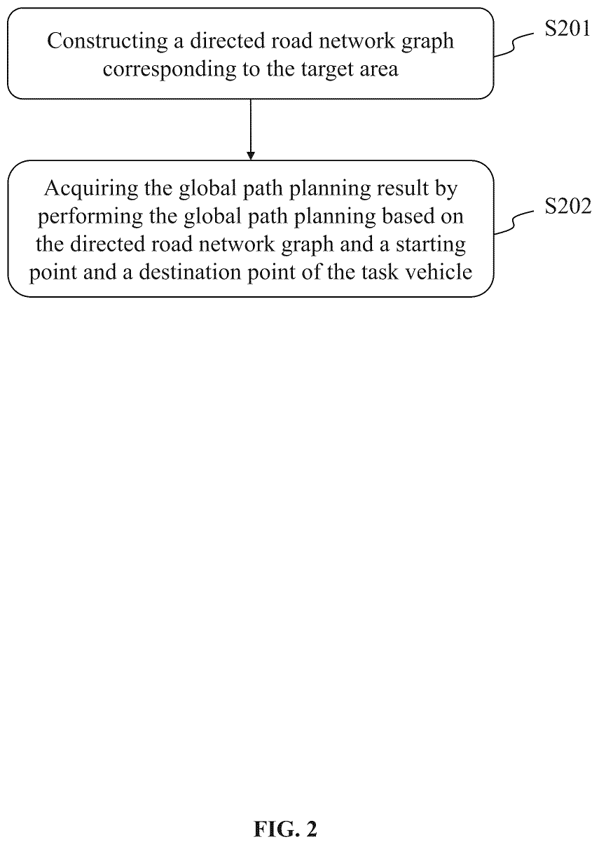

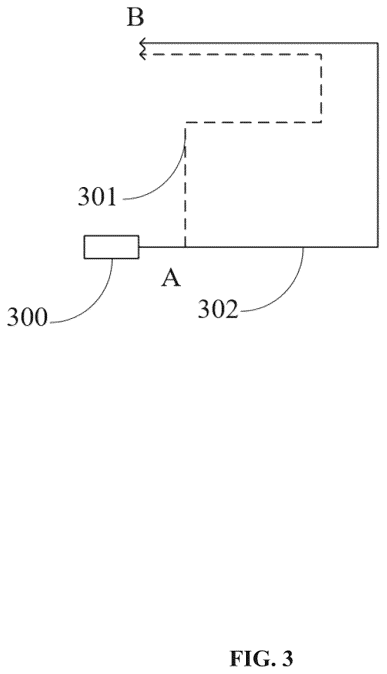

In some embodiments, the dispatching platform may perform the global path planning after determining the starting point and the destination point of each task vehicle. In some embodiments, the dispatching platform may perform the global path planning based on a multi-source and multi-destination group path planning algorithm (e.g., a Floyd algorithm). In some embodiments, the dispatching platform may construct a directed road network graph corresponding to the target area and perform the global path planning on the unmanned vehicle fleet based on the directed road network graph. More details may be found in FIG. 2 and FIG. 3 and related descriptions thereof, which are not repeated here.

In some embodiments, during the execution of the operation tasks by the unmanned vehicle fleet, states (e.g., a task execution state, an idle state, etc.) of the task vehicles in the unmanned vehicle fleet change dynamically as tasks are executed, completed, newly added tasks are started, or the like.

In some embodiments, in response to a newly added task, the dispatching platform may determine a newly added vehicle in the unmanned vehicle fleet; determine a starting point and a destination point of the newly added vehicle based on the newly added task; and acquire the global path planning result by performing the global path planning based on existing task paths of existing task vehicles in the unmanned vehicle fleet and the starting point and the destination point of the newly added vehicle.

The “newly added task” refers to an operation task corresponding to the newly added vehicle. The “newly added vehicle” can be understood as a task vehicle in the idle state or a task vehicle newly joining the current unmanned vehicle fleet. An “existing task vehicle” can be understood as a task vehicle in the task execution state in the current unmanned vehicle fleet.

In some embodiments, the dispatching platform may use a task vehicle corresponding to the newly added task as the newly added vehicle. Similar to the task vehicle, the dispatching platform may decouple the newly added task to determine the starting point and the destination point of the newly added vehicle.

In some embodiments, when performing the global path planning based on the existing task paths of the existing task vehicles in the unmanned vehicle fleet and the starting point and the destination point of the newly added vehicle, the dispatching platform may keep the existing task paths of the existing task vehicles unchanged and plan a task path for the newly added vehicle based on the directed road network graph and the starting point and the destination point of the newly added vehicle. In this case, the global path planning result includes the existing task paths of the existing task vehicles and a newly added task path of the newly added vehicle. In some embodiments, when planning the task path for the newly added vehicle, a collision probability between the task path of the newly added vehicle and the existing task paths may be considered, and a newly added task path with a lower collision probability with the existing task paths may be planned with priority. By keeping the existing task paths unchanged, overall computational load can be reduced, and planning efficiency can be improved.

In some embodiments, when performing the global path planning based on the existing task paths of the existing task vehicles in the unmanned vehicle fleet and the starting point and the destination point of the newly added vehicle, the dispatching platform may perform the global path planning according to real-time positions of the existing task vehicles, starting points and destination points of the existing task paths, and the starting point and the destination point of the newly added vehicle to obtain the global path planning result. In this case, the existing task paths of the existing task vehicles and the starting point and the destination point of the newly added vehicle may be considered comprehensively, and overall global planning may be performed again to determine a globally optimal global path planning result. By performing overall global planning for the existing task vehicles and the newly added vehicle, the globally optimal global path planning result may be determined, and the accuracy of global planning may be improved.

In some embodiments, the dispatching platform may comprehensively consider computational load and accuracy, keep a part of the existing task paths unchanged, and perform overall planning for a part of the existing task vehicles and the newly added vehicle.

In S102, a local task path of the task vehicle is determined based on driving information corresponding to the task vehicle and reference information corresponding to the global task path.

The driving information corresponding to the task vehicle refers to information detected or perceived by the task vehicle during driving. In some embodiments, the driving information corresponding to the task vehicle may include vehicle positioning information, target detection information (also referred to as “obstacle information”), etc., or any combination thereof. The vehicle positioning information refers to real-time position information detected by a positioning device of the task vehicle. The target detection information refers to related information (e.g., a position, a category, a shape, a size, etc.) of a target (e.g., a vehicle, a pedestrian, roadside equipment, an animal, a stone, other task vehicles, etc.) within a perception range of the task vehicle detected by a detection device (e.g., a radar, a camera, a wheel speed meter, etc.) of the task vehicle.

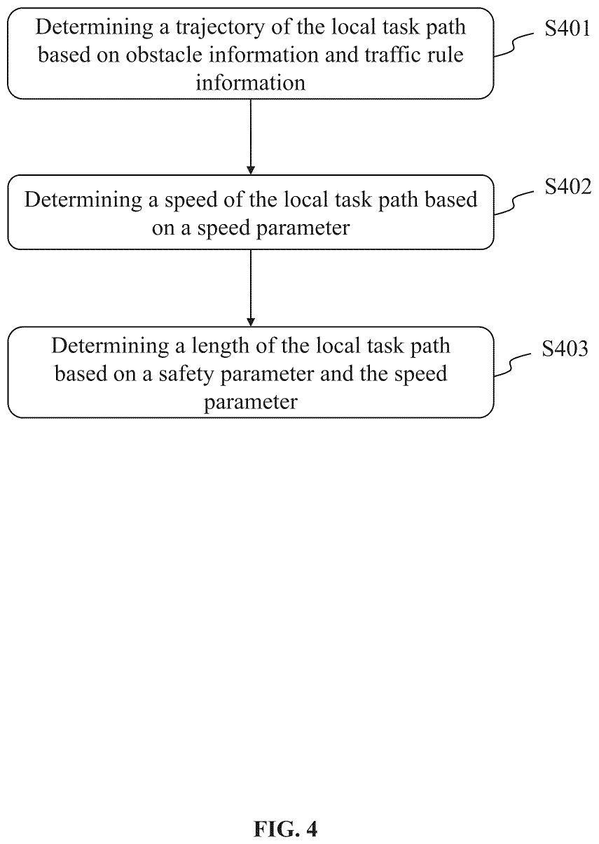

The reference information corresponding to the global task path refers to reference information (e.g., traffic information) related to a part of the global task path near (e.g., within a preset range, within a preset distance, etc.) a current position of the task vehicle. In some embodiments, the reference information corresponding to the global task path may include traffic rule information (e.g., turning left from a leftmost lane, turning right from a rightmost lane, waiting only behind a stop line, etc.) corresponding to the part of the global task path near (e.g., within the preset range, within the preset distance, etc.) the current position of the task vehicle. In some embodiments, the reference information corresponding to the global task path may further include a speed parameter, a safety parameter, etc., for planning the local task path. More descriptions regarding the speed parameter may be found in the descriptions of the operation S402 in FIG. 4, and more descriptions regarding the safety parameter may be found in the descriptions of the operation S403 in FIG. 4.

The local task path of the task vehicle refers to a local path of the task vehicle within a future preset time period. In some embodiments, the dispatching platform may comprehensively consider the real-time driving information corresponding to the task vehicle and the reference information corresponding to the global task path (or a part thereof) to plan the local task path to achieve safe and efficient intelligent control.

In some embodiments, the dispatching platform may determine a trajectory (e.g., a trajectory that avoids obstacles and complies with traffic rules) of the local task path based on the obstacle information and the traffic rule information, and determine a speed and a length of the local task path in combination with the speed parameter (e.g., a maximum road speed limit) and the safety parameter (e.g., a safety length, a safety duration). More details may be found in FIG. 4 to FIG. 6 and related descriptions thereof, which are not repeated here.

In the embodiments of the present disclosure, by comprehensively considering the obstacle information, the traffic rule information, the speed parameter, and the safety parameter for the local path planning, safety can be ensured while the speed of the task vehicle is increased as much as possible, thereby improving overall efficiency and dispatching accuracy of the unmanned vehicle fleet.

In S103, optimized local task path information is generated by optimizing the local task path based on attribute information of the local task path.

The attribute information of the local task path refers to information related to the inherent attributes of the local task path. In some embodiments, the attribute information of the local task path may include the trajectory of the local task path, the speed of the local task path, the length of the local task path, a priority of the local task path, obstacle information corresponding to the local task path, etc., or any combination thereof.

The trajectory of the local task path can reflect a shape, a direction, a trend, etc., of the local task path.

The speed of the local task path can reflect the speed characteristics of a plurality of trajectory points of the local task path. For example, the speed of the local task path may include speeds corresponding to the plurality of trajectory points of the local task path respectively, a global average speed, a maximum speed, a minimum speed, etc., or any combination thereof.

The length of the local task path can reflect a distance, a mileage, etc., between a starting position (e.g., the current position of the task vehicle) and an ending position of the local task path.

The priority of the local task path can reflect a priority level for passing of the local task path or the corresponding task vehicle.

The obstacle information corresponding to the local task path can reflect the attribute information of an obstacle within a preset range of the local task path. For example, the obstacle information corresponding to the local task path may include a position, a category, a shape, a size, etc., of an obstacle located within the preset range of the local task path. The preset range is set based on experience.

In some embodiments, the dispatching platform may comprehensively consider the attribute information of each local task path to optimize the traffic passing strategy, trajectory, length, speed, etc., of the local task path, thereby avoiding a collision between the task vehicles corresponding to different local task paths or avoiding a collision between the local task path and a nearby obstacle.

In some embodiments, the dispatching platform may optimize the local task path based on the attribute information of the local task path and an objective function.

In some embodiments, the objective function may be determined based on a similarity between the local task path before optimization and the local task path after optimization, and a correlation between different local task paths. In some embodiments, the correlation between different local task paths (also referred to as a “correlation metric,” a “correlation value,” or a “conflict correlation”) may reflect a collision probability between the task vehicles corresponding to the different local task paths.

In some embodiments, the objective function may be determined based on the similarity between the local task path before optimization and the local task path after optimization, the correlation between different local task paths, and the priority of the local task path.

The optimized local task path information refers to a driving plan obtained after optimizing the local task path. In some embodiments, the optimized local task path information may include an optimized local task path and/or a traffic passing strategy of the task vehicle corresponding to the local task path. The optimized local task path refers to a re-obtained task path after the local task path is optimized. The traffic passing strategy refers to a traffic rhythm corresponding to the task vehicle, such as whether the task vehicle passes or waits at each road section, and a corresponding driving speed, driving direction, etc., during passing.

More details regarding the local path optimization may be found in FIG. 7 to FIG. 12 and related descriptions thereof, which are not repeated here.

In the embodiments of the present disclosure, by considering the similarity between the local task path before optimization and the local task path after optimization, the correlation (collision probability) between different local task paths, the priority of the local task path, etc., overall planning efficiency and accuracy can be further improved while ensuring safety when optimizing the local task path.

In some embodiments, the dispatching platform may send the optimized local task path information to the task vehicle after the optimized local task path information is obtained through optimizing the local task path. The task vehicle passes or waits according to the received traffic passing strategy after receiving the local task path information, and travels along the optimized local task path.

According to the method for dispatching the unmanned vehicle fleet described in the embodiments of the present disclosure, the global path planning is first performed on the unmanned vehicle fleet in the target area to obtain the global path planning result. Second, the local task path of the task vehicle is determined based on the driving information corresponding to the task vehicle and the reference information corresponding to the global task path. Then, the local task path is optimized based on the attribute information of the local task path to obtain the optimized local task path information. The method for dispatching the unmanned vehicle fleet described in the embodiments of the present disclosure, not only can perform unified global path planning on the unmanned vehicle fleet, but also can plan the local task paths of fleet vehicles during driving by combining the real-time driving information of the vehicles and comprehensively considering various external factors, and perform reverse local optimization, which can ensure safety while effectively improving overall efficiency and dispatching accuracy of the unmanned vehicle fleet, and can be promoted and applied to various complex scenarios since no additional installation of traffic lights, isolation equipment, etc., is required.

Furthermore, whether for local task path planning or further optimization of the local task path, the method for dispatching the unmanned vehicle fleet described in the present disclosure performs planning and optimization from a global level (rather than only for a single task vehicle or a single intersection), thereby improving the dispatching efficiency and accuracy of the entire unmanned vehicle fleet.

In some embodiments, during task execution, the dispatching platform may dynamically and cyclically execute the operations S101, S102, and S103 to dynamically update the global task path, the local task path, and the optimized local task path information. In some embodiments, the dispatching platform may perform global path planning at a first preset time interval and perform local task path planning at a second preset time interval, wherein the first preset time interval (e.g., 10 seconds) is greater than the second preset time interval (e.g., 1 second). Merely by way of example, the dispatching platform detects whether a newly added task exists at a 10-second level. In response to determining that the newly added task exists, the dispatching platform responds to the newly added task, performs the global path planning on the unmanned vehicle fleet in the target area, and updates the global path planning result. In addition, the dispatching platform updates the local task path at a 1-second level. Overall dispatching efficiency of the unmanned vehicle fleet can be improved while ensuring safety by setting different update intervals.

It should be noted that the above description of the overall process is merely for illustration and explanation, and does not limit the scope of the present disclosure. For those skilled in the art, various modifications and changes to the above process can be made under the guidance of the present disclosure. However, these modifications and changes are still within the scope of the present disclosure.

FIG. 2 is a flowchart illustrating an exemplary process for performing global path planning on an unmanned vehicle fleet in a target area according to some embodiments of the present disclosure.

In S201, a directed road network graph corresponding to a target area is constructed.

The directed road network graph is used to reflect a road distribution in the target area. In some embodiments, the dispatching platform may serve a road intersection (i.e., intersections) in the target area as a node and serve a road between two intersections as an edge to construct the directed road network graph. In some embodiments, the dispatching platform may construct the directed road network graph based on a map (e.g., an electronic map) of the target area.

In some embodiments, in the directed road network graph, the node denotes an intersection, the edge denotes a road, and a weight of the edge is related to at least one of a road length or an intersection capacity. Merely by way of example, the longer the road length, the greater the weight of the edge; the greater the intersection capacity, the smaller the weight of the edge; and in particular, when the intersection capacity is low, the weight increases rapidly.

The road length refers to a total length from one end of a road to another end of the road. The intersection capacity is used to measure a traffic efficiency and the anti-congestion capability of an intersection within a preset period. For example, the intersection capacity may be the maximum vehicle flow that can pass through the intersection within the preset period. The preset period is determined based on actual demands.

In some embodiments, the weight of the edge may be defined as follows.

$${G}_{ij} = exp \{ - {T}_{L} / {L}_{r} \} \cdot {T}_{c} / {C}_{r} , \qquad ( 1 )$$

where Gᵢⱼ denotes the weight of the edge; Lᵣ denotes the road length; T_{L} denotes a road constraint parameter used to constrain a value range; Cᵣ denotes the intersection capacity; and T_{C} denotes an intersection constraint parameter used to constrain a value range. In some embodiments, T_{L} and T_{C} may be determined based on historical data of the target area. In some embodiments, T_{L} and T_{C} may be system default values or user-set values. In some embodiments, T_{L} and T_{C} may be dynamically adjusted for different application scenarios.

In S202, a global path planning result is acquired by performing global path planning based on the directed road network graph and a starting point and a destination point of a task vehicle.

In some embodiments, the dispatching platform may perform the global path planning based on a multi-source and multi-destination group path planning algorithm (e.g., a Floyd algorithm). In some embodiments, the global path planning result is globally or group optimal, rather than individually optimal.

Merely by way of example, FIG. 3 is a schematic diagram illustrating a global path planning result according to some embodiments of the present disclosure. As shown in FIG. 3, a starting point of a task vehicle 300 is a point A, and a destination point of the task vehicle 300 is a point B. A plurality of paths are available between point A and point B (e.g., a first path 301 and a second path 302, and a length of the first path 301 is shorter than a length of the second path 302). From an individual optimal perspective, a planned path of the task vehicle 300 should be the first path 301; but from a global optimal perspective, path conflicts with other task vehicles, path lengths of the other task vehicles, etc., need to be comprehensively considered to select the second path 302 that is optimal for the global.

It should be noted that the above description of the process of the global path planning is merely for illustration and explanation, and does not limit the scope of the present disclosure. For those skilled in the art, various modifications and changes to the above process can be made under the guidance of the present disclosure. However, these modifications and changes are still within the scope of the present disclosure.

FIG. 4 is a flowchart illustrating an exemplary process for performing local path planning on a task vehicle according to some embodiments of the present disclosure.

In S401, a trajectory of a local task path is determined based on obstacle information and traffic rule information.

With reference to operation S102, the obstacle information may be related information (e.g., a position, a category, a shape, a size, etc.) of a target (e.g., a vehicle, a pedestrian, roadside equipment, an animal, a stone, other task vehicles, etc.) within a perception range of a task vehicle. The traffic rule information may be related rules (e.g., turning left from the leftmost lane, turning right from the rightmost lane, waiting only behind a stop line, etc.) for a vehicle to drive on a road.

Correspondingly, the trajectory of the local task path is a trajectory that avoids obstacles near the task vehicle and complies with traffic rules.

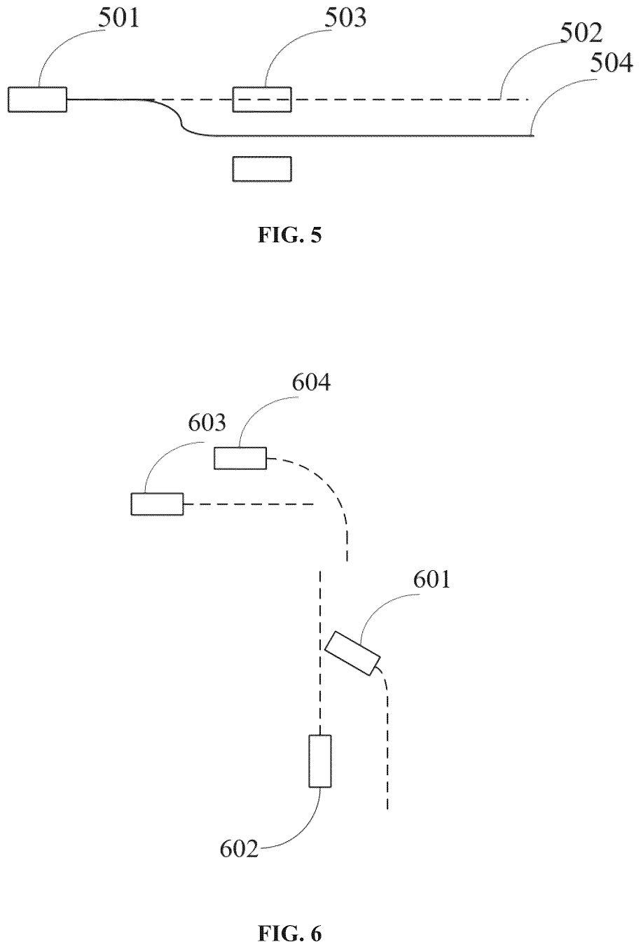

Merely by way of example, FIG. 5 is a schematic diagram illustrating a local path planning result according to some embodiments of the present disclosure. As shown in FIG. 5, after global path planning, a global task path of a task vehicle 501 is 502. After local task path planning, a local task path of the task vehicle 501 is 504, which avoids a nearby obstacle 503 (e.g., a pedestrian, a vehicle, etc.).

In S402, a speed of the local task path is determined based on a speed parameter.

In some embodiments, the dispatching platform may set the speed of the local task path based on the speed parameter. For example, speeds of all path points of the local task path are set to be the same as the speed parameter. As another example, an average speed of the local task path is set to be the same as the speed parameter. As another example, a maximum speed of the local task path is set to be the same as the speed parameter.

The speed parameter is used to constrain a driving speed of the task vehicle. In some embodiments, the speed parameter may be a maximum road speed limit. In some embodiments, the speed parameter may be a historically achieved maximum speed. In some embodiments, the speed parameter may be a maximum safe speed that matches a task type or a vehicle type. For example, the greater the load of the task vehicle, the lower the maximum safe speed. In some embodiments, the speed parameter may be a preset maximum speed of the vehicle.

In the embodiments of the present disclosure, during planning the local task path, by increasing the speed of the local task path as much as possible, the work efficiency of the unmanned vehicle fleet can be increased as much as possible.

In S403, a length of the local task path is determined based on a safety parameter and the speed parameter.

In some embodiments, the dispatching platform may comprehensively consider safety and efficiency to plan the length of the local task path. The safety parameter is used to ensure the driving safety of the task vehicle. In some embodiments, the safety parameter may include a safety length, a safety duration, or the like. In some embodiments, the safety length and/or the safety duration may be used to ensure safe stopping and/or starting of the task vehicle.

In some embodiments, the dispatching platform may determine the length of the local task path based on the following formula.

$${w}_{i} = {w}_{basis} + {v}_{i} \cdot {t}_{basis} , \qquad ( 2 )$$

where wᵢ denotes the length of the local task path; w_{basis} denotes the safety length (which may also be referred to as a “safety tolerance”); vᵢ denotes the speed parameter (e.g., the maximum road speed limit); and t_{basis} denotes the safety duration. In some embodiments, t_{basis} may be determined based on historical data of the target area. In some embodiments, t_{basis} may be a system default value or a user-set value. In some embodiments, t_{basis} may be dynamically adjusted for different application scenarios.

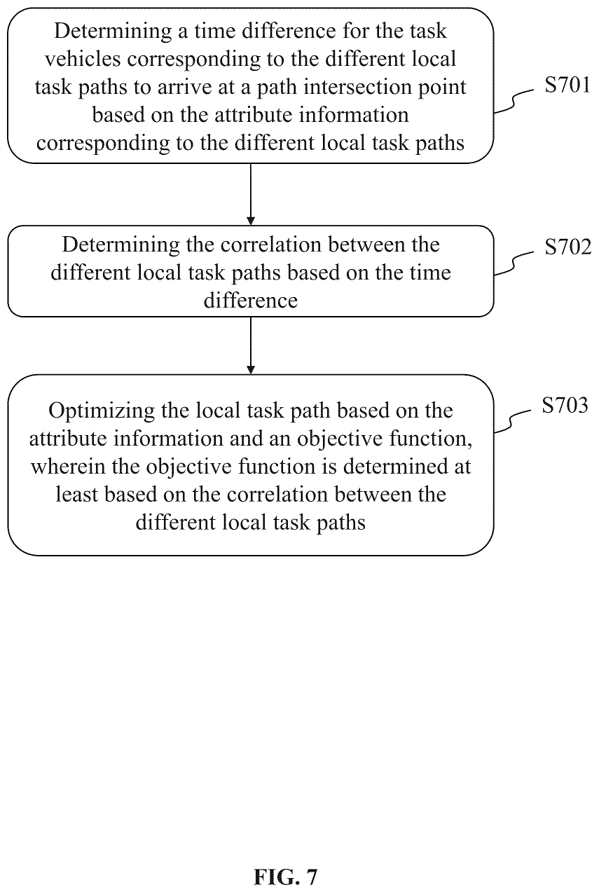

Merely by way of example, FIG. 6 is a schematic diagram illustrating local task paths of task vehicles according to some embodiments of the present disclosure. As shown in FIG. 6, for four task vehicles, after local path planning, a first local task path corresponding to a first task vehicle 601, a second local task path corresponding to a second task vehicle 602, a third local task path corresponding to a third task vehicle 603, and a fourth local task path corresponding to a fourth task vehicle 604 are determined respectively.

It should be noted that the above description of the process of the local path planning is merely for illustration and explanation, and does not limit the applicable scope of the present disclosure. For those skilled in the art, various modifications and changes may be made to the above process under the guidance of the present disclosure. However, these modifications and changes are still within the scope of the present disclosure.

FIG. 7 is a flowchart illustrating an exemplary process for optimizing a local task path according to some embodiments of the present disclosure.

In S701, a time difference for task vehicles corresponding to different local task paths to arrive at a path intersection point is determined based on attribute information corresponding to the different local task paths.

The path intersection point refers to a position where local task paths of a plurality of task vehicles overlap in space. Correspondingly, the time difference for the task vehicles to arrive at the path intersection point refers to a predicted time difference for the plurality of task vehicles to arrive at the path intersection point. In some embodiments, the dispatching platform may determine the time difference for the task vehicles corresponding to the different local task paths to arrive at the path intersection point based on trajectories, speeds, lengths of the different local task paths, real-time positions of the corresponding task vehicles, or the like.

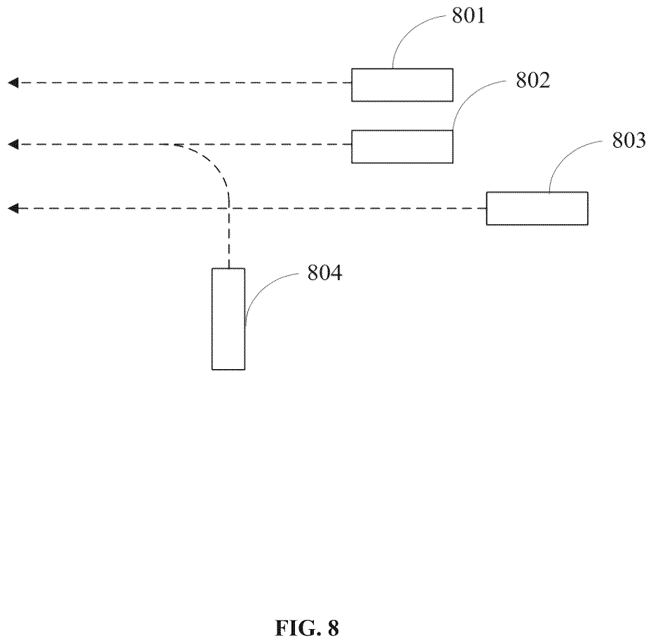

Merely by way of example, FIG. 8 is a schematic diagram illustrating a time difference for task vehicles corresponding to different local task paths to arrive at a path intersection point according to some embodiments of the present disclosure. As shown in FIG. 8, a local task path of a task vehicle 801 has no path intersection point with local task paths of other task vehicles, meaning a collision is impossible; a task vehicle 802 and a task vehicle 804 will both arrive at the path intersection point of corresponding local task paths of the task vehicle 802 and the task vehicle 804 after 2 seconds, so the time difference is 0 seconds; for a task vehicle 803 and the task vehicle 804, the task vehicle 803 will arrive at the path intersection point of corresponding local task paths of the task vehicle 803 and the task vehicle 804 after 5 seconds, and the task vehicle 804 will arrive at the path intersection point after 1 second, so the time difference is 4 seconds.

In S702, a correlation between the different local task paths is determined based on the time difference.

In some embodiments, the larger the time difference for the task vehicles to arrive at the path intersection point, the lower a collision probability between the task vehicles, and thus the lower the correlation between the corresponding local task paths; and the smaller the time difference for the task vehicles to arrive at the path intersection point, the higher the collision probability between the task vehicles, and thus the higher the correlation between the corresponding local task paths.

In some embodiments, the correlation between the different local task paths may be defined as follows.

$${l}_{ij} = \frac{{T}_{tcc}}{{tcc}_{ij}} , \qquad ( 3 )$$

where lᵢⱼ denotes a correlation between two local task paths; tccᵢⱼ denotes the time difference for the task vehicles corresponding to the two local task paths to arrive at the path intersection point; the smaller the time difference, the larger the lᵢⱼ, and lᵢⱼ approaches infinity when the time difference approaches 0; the larger the time difference, the smaller the lᵢⱼ; and in particular, if the two local task paths have no path intersection point, then lᵢⱼ=0; and T_{tcc} denotes a correlation constraint parameter for constraining a value range. In some embodiments, T_{tcc} may be determined based on historical data of the target area. In some embodiments, T_{tcc} may be a system default value or a user-set value. In some embodiments, T_{tcc} may be dynamically adjusted for different application scenarios. In some embodiments, in combination with formula (2), T_{tcc} may be equal to t_{basis}. In some embodiments, T_{tcc} and t_{basis} may also be unequal, or may be set independently.

In S703, the local task path is optimized based on the attribute information of the local task path and an objective function. The objective function is determined at least based on the correlation between the different local task paths.

In some embodiments, when optimizing the local task path, the objective function aims to maximize the similarity between a local task path before optimization and a local task path after optimization, and minimize the correlation between the different local task paths, thereby achieving the planning objectives of safety and efficiency.

In some embodiments, the objective function may be defined as follows.

$$min {\sum }_{i} {\sum }_{j} {x}_{i} \cdot {l}_{ij} \cdot {x}_{j} , \qquad ( 4 )$$

$$s . t . {x}_{i} = , for i ; s . t . {x}_{j} = , for j , \qquad ( 5 )$$

where [symbol] and [symbol] denotes an i-th local task path and a j-th local task path, respectively; xᵢ∈{0, 1} denotes whether the i-th local task path is selected (which may be understood as a traffic passing strategy of the local task path, e.g., if a local task path is selected, the traffic passing strategy of the local task path is “pass,” and if the local task path is not selected, the traffic passing strategy of the local task path is “wait”); xⱼ∈{0, 1} denotes whether the j-th local task path is selected; and lᵢⱼ denotes a correlation between the i-th local task path and the j-th local task path.

In the embodiments of the present disclosure, by introducing the similarity between the local task path before optimization and the local task path after optimization into the objective function, the optimized local task path may still travel at a preset speed parameter (e.g., the maximum road speed limit) as much as possible. Furthermore, by introducing the correlation between the different local task paths into the objective function, paths with a high collision probability cannot be selected simultaneously, thereby ensuring driving safety.

In some embodiments, when optimizing the local task path, a priority of the local task path may also be introduced into the objective function. That is, the objective function may be determined based on the similarity between the local task path before optimization and the local task path after optimization, the correlation between the different local task paths, and the priority of the local task path. More details regarding the priority may be found below.

In the embodiments of the present disclosure, on the basis of introducing the similarity between the local task path before optimization and the local task path after optimization, and the correlation between the different local task paths, by further introducing the priority of the local task path into the objective function, the efficiency of optimizing the local task path can be further improved.

In some embodiments, the dispatching platform may perform optimization solving for the local task path based on a graph theory solving scheme.

In some embodiments, an objective function matrix may be defined as follows.

$$J = {( X - \hat{X} )}^{T} {I}_{c} ( X - \hat{X} ) + λ \cdot {X}^{T} \cdot L \cdot X , \qquad ( 6 )$$

where \hat{X} denotes a matrix representation of the local task path, e.g., \hat{X} is a matrix formed by the local task path [symbol] X denotes a matrix representation of whether the local task path is selected after optimization, e.g., X is a matrix formed by xᵢ; L denotes a matrix representation of the correlation between the local task paths (which may also be referred to as a “correlation matrix”), e.g., L is a matrix formed by lᵢⱼ; I_{c} denotes a matrix representation of the priorities or confidence levels of the local task paths (which may also be referred to as a “priority matrix” or a “confidence matrix”), e.g., I_{c} denotes a diagonal matrix formed by priorities or confidence levels cᵢ; and λ is a preset parameter for balancing weights of the similarity and the priorities.

In some embodiments, the priority (or the confidence level) of the local task path may be related to a task priority of an operation task executed by the corresponding task vehicle. For example, the higher the task priority, the higher the priority of the local task path. For example, a ship loading task has the highest priority, a ship unloading task has a second-highest priority, and a container moving task has a lowest priority, etc. In some embodiments, the priority (or the confidence level) of the local task path may be related to a historical waiting duration of the corresponding task vehicle. For example, the longer the historical waiting duration, the higher the priority; and if the task vehicle has never waited historically, the priority may even be set to 0 (i.e., the priority of the local task path of the task vehicle does not need to be considered during a solving process). In some embodiments, when determining the priority (or the confidence level) of the local task path, the task priority and the historical waiting duration corresponding to the local task path may be comprehensively considered.

In some embodiments, the priority of the local task path may be defined as follows.

$${c}_{i} = {f}_{i} \cdot exp \{ - {T}_{t} / ‖ {t}_{i} ‖ \} , \qquad ( 7 )$$

where cᵢ denotes the priority of the local task path, fᵢ denotes the task priority corresponding to the local task path, tᵢ denotes a waiting duration of the task vehicle corresponding to the local task path, and Tₜ denotes a weight constraint parameter for constraining a weight of the waiting duration. In some embodiments, Tₜ may be determined based on historical data of the target area. In some embodiments, Tₜ may be a system default value or a user-set value. In some embodiments, Tₜ may be dynamically adjusted for different application scenarios.

In some embodiments, combining the previous descriptions, an optimization result of the local task path may be solved through a Jacobian matrix by performing a derivative on the objective function matrix based on the above description and the graph theory solving scheme. Merely by way of example, a solving process is as follows.

$$X = ( {I}_{c} + λ \cdot L ) \cdot \hat{X} . \qquad ( 8 )$$

In some embodiments, optimized local task path information (also referred to as “an optimization result of the local task path”) may include the traffic passing strategy (e.g., passing or waiting) of the task vehicle corresponding to the local task path.

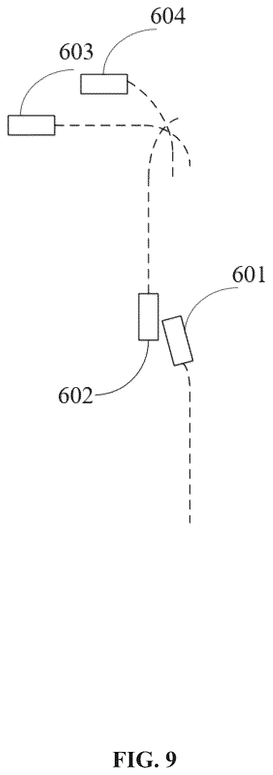

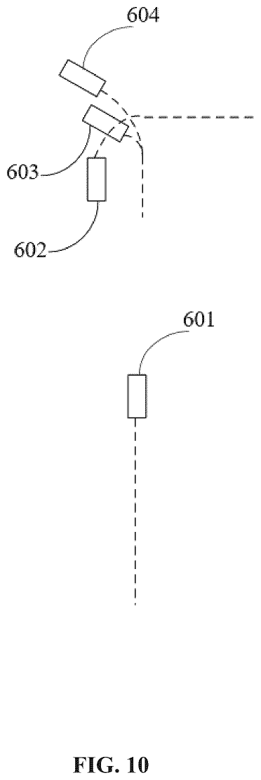

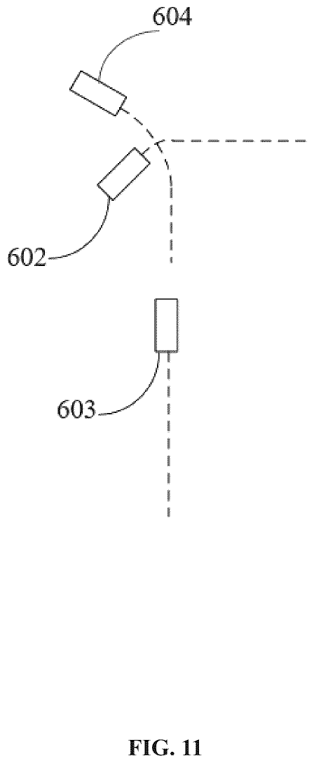

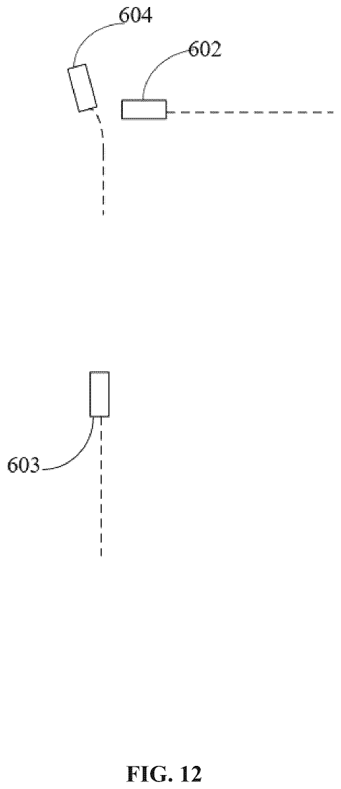

Merely by way of example, FIG. 9 is a schematic diagram illustrating an exemplary optimization process of a local task path according to some embodiments of the present disclosure. FIG. 10 is another schematic diagram illustrating an exemplary optimization process of a local task path according to some embodiments of the present disclosure. FIG. 11 is another schematic diagram illustrating an exemplary optimization process of a local task path according to some embodiments of the present disclosure. FIG. 12 is another schematic diagram illustrating an exemplary optimization process of a local task path according to some embodiments of the present disclosure. As shown in FIG. 9, in combination with FIG. 6, a local task path of the first task vehicle 601 does not have a path intersection point with local task paths of other task vehicles. Local task paths of the second task vehicle 602, the third task vehicle 603, and the fourth task vehicle 604 have a path intersection point. If each task vehicle travels according to a respective local task path, a collision may occur. Correspondingly, the dispatching platform may determine a traffic passing strategy for the first task vehicle 601, the second task vehicle 602, the third task vehicle 603, and the fourth task vehicle 604 through the above optimization process. As shown in FIG. 9, the traffic passing strategy at a current moment is as follows. The first task vehicle 601 travels normally according to a first local task path, and the second task vehicle 602, the third task vehicle 603, and the fourth task vehicle 604 all travel to a local stop line (e.g., near the path intersection point of a second local task path, a third local task path, and a fourth local task path).

Further, the optimization process of the local task path may be performed continuously and dynamically. As shown in FIG. 10, a traffic passing strategy at this moment is as follows. The first task vehicle 601 continues traveling, the third task vehicle 603 travels through the path intersection point of the second local task path, the third local task path, and the fourth local task path, and the second task vehicle 602 and the fourth task vehicle 604 wait at the local stop line.

Further, as shown in FIG. 11, the first task vehicle 601 has driven out of a range of a local path optimization, and a traffic passing strategy at this moment is as follows. The third task vehicle 603 continues traveling, the second task vehicle 602 travels through the path intersection point of the second local task path and the fourth local task path, and the fourth task vehicle 604 waits at the local stop line.

Further, as shown in FIG. 12, a traffic passing strategy at this moment is as follows. The third task vehicle 603 continues traveling, the second task vehicle 602 has traveled through the path intersection point of the second local task path and the fourth local task path, and the fourth task vehicle 604 starts traveling.

In some embodiments, the optimized local task path information (also referred to as “the optimization result of the local task path”) may further include an optimized local task path. That is, during optimizing the local task path, the dispatching platform not only considers the traffic passing strategy (e.g., passing or waiting) of the local task path, but also adjusts the local task path (e.g., adjusts the trajectory, length, speed, etc., of the local task path) during the optimization process. For example, during the optimization process, the dispatching platform may adjust the trajectory of the local task path (e.g., change a lane), thereby avoiding a collision between task vehicles corresponding to different local task paths or avoiding a collision between the local task path and an obstacle. As another example, during the optimization process, the dispatching platform may adjust the speed of the local task path (e.g., reduce the speed), thereby increasing a time difference for the different local task paths to arrive at a path intersection point, and correspondingly avoiding a collision between the corresponding task vehicles.

Correspondingly, in combination with the above Formula (6), when optimizing the local task path based on the objective function, X denotes a matrix representation of the optimized local task path and whether the optimized local task path is selected, and L denotes a matrix representation of the correlation between optimized local task paths. In combination with the operation S702, the correlation between optimized local task paths is determined based on the time difference for the task vehicles corresponding to the optimized local task paths to arrive at the path intersection point.

In some embodiments, since the correlation characterizes a collision probability between the task vehicles corresponding to different local task paths, and the local task path itself considers a safety length and a safety duration, if a change between a local task path before optimization and a local task path after optimization is small, and a change in the collision probability between the task vehicles caused by a change in a path trajectory before and after optimization is within an allowable error range, the time difference may still be determined using the local task path before optimization, and then the correlation may be determined.

It should be noted that the above description regarding the local path optimization process is merely for illustration and explanation, and does not limit the scope of application of the present disclosure. For those skilled in the art, various modifications and changes may be made to the above process under the guidance of the present disclosure. However, these modifications and changes are still within the scope of the present disclosure.

In some embodiments, the dispatching platform may further generate a control instruction based on the optimized local task path information; drive a steering actuator, a power system, and a braking system of the task vehicle to operate based on the control instruction, so that the task vehicle travels according to an optimized local task path. More descriptions regarding the optimized local task path information may be found in the description of the operation S103 in FIG. 1.

The control instruction is used to control an actuator (e.g., the steering actuator, the braking system, etc.) of the task vehicle to perform a control action (e.g., control steering, braking, etc.). In some embodiments, the control instruction may at least include a steering direction control instruction and a speed control instruction.

In some embodiments, the dispatching platform may determine the optimized local task path and/or the traffic passing strategy of the task vehicle corresponding to the local task path based on the optimized local task path information, and then determine a driving direction and a driving speed of the task vehicle, thereby generating the control instruction.

The steering actuator refers to a device installed in the task vehicle and used to control the driving direction (e.g., a steering angle) of the task vehicle. In some embodiments, the steering actuator includes a steering system. The steering system is used to adjust the driving direction of the task vehicle. In some embodiments, the steering system may be at least one of an electric power steering (EPS) system, a steering-by-wire (SBW) system, etc. The steering system may at least include a steering motor, a transmission device (e.g., a gear set), and a sensor.

The braking system refers to a system installed in the task vehicle and used to control the deceleration of the task vehicle. In some embodiments, the braking system may be at least one of a hydraulic braking system, a pneumatic braking system, etc.

The power system refers to a system installed in the task vehicle and used to control the acceleration of the task vehicle. In some embodiments, the power system may be one of an electric power system, a hybrid power system, an internal combustion engine power system, etc.

In some embodiments, the task vehicle may further include a control unit installed in the task vehicle. The control unit is configured to receive the control instruction and control operations of the steering system, the power system, the braking system, etc. In some embodiments, the control unit is communicatively connected to the dispatching platform.

In some embodiments, the dispatching platform may send the control instruction to the control unit. The control unit may obtain a target steering angle by parsing the steering direction control instruction through a path tracking algorithm; obtain a driving speed by parsing the speed control instruction through a proportional-integral-derivative (PID) algorithm or a model predictive control (MPC) algorithm, and use a minimum value between a maximum road speed limit and the driving speed as a target driving speed; adjust a steering angle of the steering actuator based on the target steering angle, thereby changing the driving direction of the task vehicle; and control operations of the power system or the braking system based on the target driving speed. In this way, the target vehicle may travel according to the optimized local task path.

In some embodiments of the present disclosure, by generating the control instruction to drive the steering actuator and the braking system of the task vehicle to operate, integration of dispatching and control can be achieved to ensure that the unmanned vehicle fleet can travel accurately according to the optimized local task path.

In some embodiments, the dispatching platform may further dynamically adjust a weight of an edge of the directed road network graph based on a historical passing time of a road, a road curvature, or a real-time traffic density. The intersection capacity is determined based on a statistical value of a vehicle flow in the target area, and the vehicle flow is collected by an acquisition device deployed in the target area.

The historical passing time reflects a congestion risk of a road. In some embodiments, the historical passing time may be obtained by statistically averaging a time for vehicles to pass the road within a historical time period. The historical time period may be determined based on actual demands. For example, the historical time period may be a historical 10:00-11:00 am or 00:00-05:00 at night, etc. In some embodiments, the weight of the edge is positively correlated with the historical passing time of the road.

The road curvature reflects a degree of curvature of a road. In some embodiments, the road curvature may be characterized by a reciprocal of a turning radius of the road. In some embodiments, the dispatching platform may determine the road curvature based on geometric data or continuous path points of the road in an electronic map. The electronic map may be obtained by being uploaded by a technician. In some embodiments, the weight of the edge is positively correlated with the road curvature.

The real-time traffic density reflects a real-time congestion situation of the road. In some embodiments, the real-time traffic density may be characterized by a count of vehicles per unit length of a preset road section, a ratio of a projection area of the vehicles on a road surface to an area of the road surface, or the like. The preset road section and the unit length are set based on actual demands, and the area of the road surface is determined by a technician's input. In some embodiments, the weight of the edge is positively correlated with the real-time traffic density.

In some embodiments, the real-time traffic density may be obtained in various ways.

For example, the dispatching platform may obtain the real-time traffic density from an acquisition device deployed in the target area. The acquisition device is configured to collect data related to the vehicles on the road, and the acquisition device is communicatively connected to the dispatching platform. In some embodiments, the acquisition device may be disposed at a location such as an intersection within the target area. In some embodiments, the acquisition device may include one of a camera, a radar, or the like. The camera is configured to collect image data and determine the real-time traffic density based on the image data through a preset algorithm (e.g., an image recognition algorithm). The radar is configured to collect radar data and determine the real-time traffic density based on the radar data.

As another example, the dispatching platform may input information of the target area (e.g., coordinates and a range of the target area) into a preset program to obtain a heat map (or a density map, or the like), and then estimate the real-time traffic density. The preset program may be an application programming interface (API), a geographic information system (GIS), or the like. In some embodiments, the real-time traffic density is positively correlated with the weight of the edge.

In some embodiments, the dispatching platform obtains, in real time or periodically (e.g., every 1 second), the real-time traffic density of the road at a certain moment in a current time period, the road curvature, and a historical passing time of a historical time period corresponding to the current time period, to redetermine the weight of each edge in the directed road network graph, thereby ensuring that the global path planning is always evaluated and obtained based on the latest data. The current time period and the corresponding historical time period have the same time label. For example, if the current time period is 10:00-11:00 am, the corresponding historical time period may be 10:00-11:00 am of the previous day, 10:00-11:00 am of the previous week, or the like.

Merely by way of example, the weight of the edge at a certain moment in the current time period may also be redetermined by the following formula (9).

$${G}_{ij} = exp \{ - {T}_{L} / {L}_{r} \} \cdot \frac{{T}_{c}}{{C}_{r}} \cdot ( \frac{{T}_{0}}{{T}_{1}} + \frac{{K}_{0}}{{K}_{1}} + \frac{{D}_{0}}{{D}_{1}} ) , \qquad ( 9 )$$

where Gᵢⱼ denotes the weight of the edge; Lᵣ denotes the road length; T_{L} denotes the road constraint parameter for constraining the value range; Cᵣ denotes the intersection capacity; T_{C} denotes the intersection constraint parameter for constraining the value range; T₀ denotes a reference passing time of the road; T₁ denotes the historical passing time of the road; K₀ denotes a reference curvature of the road; K₁ denotes the road curvature; Do denotes a reference traffic density of the road; and D₁ denotes the real-time traffic density. In some embodiments, T₀, K₀, and D₀ may be preset by a technician based on experience. In some embodiments, T₀, K₀, and D₀ may be average values of historical passing times, road curvatures, and real-time traffic densities of a plurality of roads in the current time period.

The vehicle flow refers to a count of vehicles passing a certain intersection or road section per unit time. In some embodiments, a deep learning model is embedded in the camera, and the camera is further configured to count and classify the vehicles passing the road section or the intersection based on the image data, and then determine the vehicle flow and vehicle types (e.g., whether a vehicle is a large truck or a small car, an empty vehicle or a fully loaded vehicle). In some embodiments, the radar is further configured to determine the vehicle flow based on the radar data through a target detection and tracking algorithm.

In some embodiments, the dispatching platform may determine a vehicle flow corresponding to a road without congestion based on a plurality of historical vehicle flows (i.e., statistical values of the vehicle flows) collected by the acquisition device; and after excluding existing vehicles at the current intersection, count a maximum vehicle flow (i.e., intersection capacities corresponding to the different directions) that may currently pass in different directions (e.g., a left-turn direction, a right-turn direction, and/or a straight direction) of the intersection. The historical vehicle flow refers to a vehicle flow collected at a historical moment, and the current vehicle flow refers to a vehicle flow collected at a current moment.

It is worth noting that since volumes of vehicles of different categories are different, and driving speeds of vehicles with different weights are different, the types and quantities of task vehicles that may be arranged are affected. For example, road widths, road lengths, and intersection capacities (i.e., a count of vehicles that can pass), of a straight direction and a left-turn direction are the same, however, since more large trucks and fully loaded vehicles are on the straight direction than that on the left-turn direction, a driving speed of the straight direction is slower, so that the straight direction can accommodate fewer vehicles of a same type (i.e., a same volume and load). Therefore, in some embodiments, the dispatching platform may adjust types and quantities (i.e., adjust the intersection capacities) of the task vehicles in different directions based on the intersection capacities of the different directions, vehicle types, or the like.

In some embodiments of the present disclosure, by introducing the road curvature and the real-time traffic density in real time or periodically, the weight of the edge can accurately reflect actual passing efficiency and passing difficulty of the road, so that road sections with low traveling efficiency (e.g., currently congested or about to be congested) or high safety risks (e.g., a large road curvature easily causing the task vehicle to roll over) can be avoided in advance, thereby improving operating efficiency of the unmanned vehicle fleet. In addition, by collecting actual vehicle flow and vehicle types in real time through the camera or the radar, the intersection capacity can better fit reality, which is beneficial for adjusting types and quantities of task vehicles in different directions subsequently, and further improving the operating efficiency of the unmanned vehicle fleet.

In some embodiments, the intersection capacity is negatively correlated with the size information of an existing task vehicle passing through the intersection.

The size information of the existing task vehicle includes geometric data such as a length, a width, and a height of the existing task vehicle that is about to pass through. In some embodiments, a numerical value corresponding to the size information of the existing task vehicle may be a dynamic value, and the size information is determined based on a dynamic swept area. The dynamic swept area refers to a projection of a vehicle body of the task vehicle on the ground while the task vehicle travels along the local task path. In some embodiments, the dynamic swept area may be obtained by analyzing the image data collected by the camera. More descriptions regarding the dynamic swept area may be found in the following description.

It is worth noting that the larger the size information of the existing task vehicle, the more space and time resources the existing task vehicle occupies when passing through the intersection, and therefore, a count of other task vehicles that can pass through the intersection decreases (i.e., the intersection capacity decreases).

In some embodiments, when the global path planning result is that task paths of one or more task vehicles with size information greater than a first size threshold need to pass through a certain intersection, the dispatching platform may determine a minimum time and a maximum occupied space required for the one or more task vehicles to pass through the intersection based on the size information of the one or more task vehicles. During a time period when one or more task vehicles are expected to pass through the intersection, the dispatching platform may adjust the intersection capacity of the intersection, and an adjusted intersection capacity is used to guide path planning for subsequent other task vehicles (e.g., task vehicles with size information less than a second size threshold). The first size threshold and the second size threshold are set based on experience.

Merely by way of example, the adjusted intersection capacity may be determined by the following formula (10)

$${N}_{1} = {N}_{0} ( 1 - \frac{{DIM}_{1}}{{DIM}_{0}} \cdot {A}_{0} ) , \qquad ( 10 )$$

where N₁ denotes the adjusted intersection capacity; N₀ denotes an intersection capacity before adjustment; DIM₁ denotes size information of a current task vehicle; DIM₀ denotes reference size information; and A₀ denotes a reference deduction capacity. The reference deduction capacity refers to an intersection capacity that needs to be deducted when a task vehicle with size information greater than the first size threshold passes through the intersection. The reference size information refers to size information corresponding to a standard task vehicle, and the standard task vehicle and the size information corresponding to the standard task vehicle are determined by a technician's input.

After the task vehicle with the size information greater than the first size threshold passes through the intersection, the intersection capacity of the intersection returns to the intersection capacity before adjustment. At this time, the intersection capacity of the intersection is only affected by the current real-time traffic density.

According to some embodiments of the present disclosure, by adjusting the intersection capacity based on the size information of the existing task vehicle, a defect of a traditional dispatching mode that treats all task vehicles as a homogeneous model may be overcome. Fine-grained allocation of subsequent resources is performed based on actual space-time resources occupied by the task vehicle, thereby avoiding planning large-sized task vehicles to pass through the same intersection in the same time period, so that congestion at the intersection caused by slow passage of large-sized task vehicles is effectively prevented, and the operation efficiency of the unmanned vehicle fleet is further improved.

In some embodiments, the dispatching platform may determine dynamic characteristics of the task vehicle through a vehicle dynamics model based on a real-time load of the task vehicle, a center-of-gravity position of the task vehicle, a road gradient of the local task path corresponding to the task vehicle, and an adhesion coefficient between a tire and a road surface; determine a maximum recommended speed based on the dynamic characteristics; determine a maximum allowable speed based on a maximum road speed limit, a historical maximum road speed, a maximum safe speed corresponding to a task/vehicle type, a system limit speed of the task vehicle, and the maximum recommended speed; and limit the speed of the local task path to not exceed the maximum allowable speed.

The real-time load of the task vehicle refers to a weight of cargo carried by the task vehicle. The road gradient of the local task path corresponding to the task vehicle refers to an angle between a surface of a road and a horizontal plane. The adhesion coefficient between the tire and the road surface is used to measure an adhesion capability of the tire on different road surfaces. In some embodiments, the real-time load of the task vehicle, the road gradient of the local task path corresponding to the task vehicle, and the adhesion coefficient between the tire and the road surface may be determined by a technician inputting.

The center-of-gravity position of the task vehicle refers to a position of an action point of a resultant force on the task vehicle. In some embodiments, the center-of-gravity position may be obtained by an inertial measurement unit disposed in the task vehicle.

The dynamic characteristics refer to the power parameters of the task vehicle in a safe driving state. In some embodiments, the dynamic characteristics may include a maximum safe acceleration, a maximum safe deceleration, and a maximum stable turning speed of the task vehicle. The maximum safe deceleration affects an emergency braking distance of the task vehicle, and the maximum stable turning speed refers to a maximum driving speed at which the task vehicle remains stable when turning.

In some embodiments, the vehicle dynamics model is a machine learning model. For example, the vehicle dynamics model may be one or a combination of a neural network (NN) model or other customized models.

In some embodiments, the vehicle dynamics model may be trained by a plurality of first training samples with first labels. For example, the plurality of first training samples with the first labels may be input into an initial vehicle dynamics model, a loss function may be constructed based on the first labels and a result of the initial vehicle dynamics model, and parameters of the initial vehicle dynamics model may be iteratively updated based on the loss function. When a preset condition is satisfied, model training is completed, and a trained vehicle dynamics model is obtained. The preset condition may be convergence of the loss function, a count of iterations reaching a threshold, etc. Manners for iteratively updating include a gradient descent method or a simulated annealing algorithm, etc.

The first training sample includes a real-time load of a sample task vehicle, a center-of-gravity position of the sample task vehicle, a road gradient of a local task path corresponding to the sample task vehicle, and an adhesion coefficient between a tire of the sample task vehicle and a road surface. The first label may include sample dynamic characteristics corresponding to the first training sample.

In some embodiments, the first training sample may be constructed from historical data. The first label may be constructed based on a maximum acceleration (i.e., a sample maximum safe acceleration), a maximum deceleration (i.e., a sample maximum safe deceleration), and a maximum stable turning speed (i.e., a sample maximum stable turning speed) actually adopted by the sample task vehicle when no accident occurs or traffic hazard (e.g., cargo dropping) is caused in a plurality of subsequent driving processes corresponding to the first training sample.

The maximum recommended speed refers to a maximum driving speed recommended based on the dynamic characteristics. In some embodiments, the dispatching platform may determine the maximum recommended speed by querying a first preset table based on the dynamic characteristics.

In some embodiments, the first preset table includes different dynamic characteristics of different task vehicles and corresponding maximum recommended speeds. The first preset table is constructed based on experiments. For example, for a certain type of task vehicle, under certain dynamic characteristics, through a plurality of experiments, an average value of maximum speeds at which the task vehicle maintains stable passage in the plurality of experiments is taken as the maximum recommended speed of the type of task vehicle under the dynamic characteristics. Through the above method, maximum recommended speeds of a plurality of types of task vehicles under different dynamic characteristics are determined, and the first preset table is constructed.

The maximum road speed limit refers to a maximum driving speed allowed on a road (i.e., a road speed limit). In some embodiments, the maximum road speed limit may be obtained from a map or traffic rule information.

The historical maximum road speed refers to a maximum driving speed at which the task vehicle or a vehicle of a same type has actually safely traveled on a road segment in historical data. In some embodiments, the historical maximum road speed may be obtained from historical data of the task vehicle or the vehicle of the same type traveling on the road.

The maximum safe speed corresponding to the task/vehicle type refers to a maximum driving speed set based on an operation task type (e.g., whether an operation task is urgent) and/or a vehicle type (e.g., whether a vehicle is a fully loaded vehicle or an empty vehicle) to ensure driving safety and cargo stability. In some embodiments, the maximum safe speed corresponding to the task/vehicle type may be preset by a technician.

The system limit speed of the task vehicle refers to a theoretical maximum driving speed that hardware and a braking system of the task vehicle can achieve. In some embodiments, the system limit speed of the task vehicle may be obtained from a factory report of the task vehicle.

The maximum allowable speed refers to a maximum driving speed allowed for the task vehicle after multi-dimensional evaluation. In some embodiments, the dispatching platform may take a minimum value among the maximum road speed limit, the historical maximum road speed, the maximum safe speed corresponding to the task/vehicle type, the system limit speed of the task vehicle, and the maximum recommended speed as the maximum allowable speed.

In some embodiments, the dispatching platform may send the maximum allowable speed to a control unit of the task vehicle, and the control unit controls the braking system to limit the speed of the local task path to not exceed the maximum allowable speed.

According to some embodiments of the present disclosure, comprehensively evaluating to dynamically determine a maximum allowable speed of the task vehicle can avoid risks caused by relying solely on a maximum road speed limit and ignoring actually existing complex and high-risk scenarios (e.g., a possibility of the task vehicle overturning when turning or a decrease in adhesion on the downhill or slippery road surfaces), so that the speed limit of the local task path of the task vehicle in such scenarios can meet safety requirements, thereby significantly reducing the risk of rear-end collision or collision caused by insufficient braking distance or the risk of overturning caused by excessive turning speed.

In some embodiments, the dispatching platform may further generate a speed limiting instruction based on the maximum allowable speed; control a speed limiter of the task vehicle to operate based on the speed limiting instruction; and in response to a real-time speed of the task vehicle exceeding the maximum allowable speed, reduce the real-time speed of the task vehicle by the speed limiter

The speed limiting instruction is used to limit a maximum driving speed of the task vehicle. In some embodiments, the dispatching platform may use the maximum allowable speed of the task vehicle as the maximum driving speed of the task vehicle, then generate the speed limiting instruction, and send the speed limiting instruction to the speed limiter via a network or the like.

The speed limiter refers to a software module or a hardware actuator in the task vehicle configured to limit the maximum driving speed. In some embodiments, the speed limiter may be integrated with the braking system and/or a power system (e.g., a throttle or a motor) of the task vehicle.

The real-time speed refers to a current driving speed of the task vehicle. In some embodiments, the real-time speed of the task vehicle may be obtained via a speed monitoring module (e.g., a wheel speed sensor, a GPS system, and/or an inertial navigation system) disposed inside the task vehicle. The speed monitoring module is communicatively connected to the speed limiter.

In some embodiments, the speed monitoring module may send the real-time speed to the speed limiter, and in response to the real-time speed of the task vehicle exceeding the maximum allowable speed, the speed limiter may reduce the real-time speed in a plurality of ways. For example, the speed limiter may generate an electrical signal to adjust the operation of the power system (e.g., reduce a throttle opening or reduce a motor torque output). As another example, if the real-time speed still cannot be reduced to not exceed the maximum allowable speed after cutting off the power system in a downhill or slippery environment, the speed limiter may further activate the braking system (e.g., activate engine braking, a retarder, or slightly apply service braking) to further reduce the real-time speed.

According to some embodiments of the present disclosure, by generating the speed limiting instruction and controlling the real-time speed of the task vehicle not to exceed the maximum allowable speed, safety of the task vehicle in complex environments can be improved, and closed-loop speed control based on safety constraints can be achieved.

In some embodiments, the dispatching platform may further determine the similarity between the local task path before optimization and the local task path after optimization based on at least one of a speed deviation, a curvature deviation, or a path offset distance between the local task path before optimization and the local task path after optimization; and adjust the correlation between the different local task paths based on a road width of the local task path or size information of the task vehicle.

The speed deviation refers to a mean square error (or a maximum difference, etc.) of speed parameters between respective corresponding points of the local task path before optimization and the local task path after optimization.

The corresponding points refer to position points selected between the local task path before optimization and the local task path after optimization that have a same driving progress. The driving progress may be a ratio of a current driving distance to a total path length (or a ratio of a current used driving time to a total time required for the path, etc.).

The curvature deviation refers to a curvature difference between corresponding points of the local task path before optimization and the local task path after optimization. In some embodiments, a larger curvature deviation indicates a larger morphological difference between the local task path before optimization and the local task path after optimization.

The path offset distance refers to a minimum distance in space between corresponding points of the local task path before optimization and the local task path after optimization.

In some embodiments, the smaller the speed deviation, the curvature deviation, and the path offset distance, the greater the similarity between the local task path before optimization and the local task path after optimization. An optimization objective is to minimize the similarity, to ensure that adjustment of the local path avoids conflicts while maintaining consistency with an original path in terms of speed, trajectory, and driving comfort as much as possible.

In some embodiments, the dispatching platform aligns the local task path before optimization and the local task path after optimization in time or space via a preset algorithm (e.g., a Fréchet distance or a Dynamic Time Warping (DTW) algorithm), and then determines speed deviations, curvature deviations, and path offset distances of a plurality of corresponding points.

The similarity between the local task path before optimization and the local task path after optimization is used to measure a deviation degree of a local optimization result from a pre-planned local path. In some embodiments, the dispatching platform may determine the similarity between the local task path before optimization and the local task path after optimization in a plurality of ways based on speed deviations, curvature deviations, and path offset distances of a plurality of corresponding points.

For example, the dispatching platform determines a weighted average (or a sum of maximum values) of the speed deviations, the curvature deviations, and the path offset distances of the plurality of corresponding points, and uses the weighted average (or the sum of the maximum values) as the similarity between the local task path before optimization and the local task path after optimization. Weights are preset by a technician.

As another example, the dispatching platform may determine the similarity between the local task path before optimization and the local task path after optimization via the following formula (11).

$$SIM = exp ( 3 - \frac{{D}_{v}}{{D}_{v 0}} - \frac{{D}_{k}}{{D}_{k 0}} - \frac{{D}_{p}}{{D}_{p 0}} ) , \qquad ( 11 )$$

where SIM denotes the similarity between the local task path before optimization and the local task path after optimization; Dᵥ denotes the speed deviation; Dₖ denotes the curvature deviation; Dₚ denotes the path offset distance; Dᵥ₀ denotes a reference speed deviation; Dₖ₀ denotes a reference curvature deviation; and Dₚ₀ denotes a reference path offset distance. In some embodiments, the reference speed deviation, the reference curvature deviation, and the reference path offset distance may be preset by a technician based on experience. In some embodiments, the dispatching platform may further collect statistics on a large count of optimization results, and use average values of speed deviations, curvature deviations, and path offset distances in the large count of optimization results that meet requirements (e.g., a determined local task path or global task path has no congestion issues) as the reference speed deviation, the reference curvature deviation, and the reference path offset distance, respectively.

The road width of the local task path refers to a length of a road where the local task path is located perpendicular to a driving direction of the task vehicle. In some embodiments, the road width of the local task path may be obtained from an electronic map. More descriptions regarding the size information of the task vehicle may be found in the above descriptions.

In some embodiments, the dispatching platform may adjust the correlation between different local task paths based on the road width and the widths of the task vehicles. For example, if lanes corresponding to two local task paths are on a same road (two task vehicles driving opposite or side-by-side), and a difference between the road width and a sum of widths of the two task vehicles is less than a preset threshold, which indicates that when the two task vehicles drive side-by-side or opposite, reserved space is insufficient for the two task vehicles to safely pass each other without scraping (i.e., a potential conflict or passage difficulty exists), so that the correlation between the two local task paths needs to be adjusted. The preset threshold is set based on experience. For example, the preset threshold may be 0.

In some embodiments, the dispatching platform may further adjust the correlation between the different local task paths based on a vehicle spacing of the task vehicles. For example, when lanes corresponding to two local task paths are located on a same road (two task vehicles driving opposite or side-by-side), and a vehicle spacing between the two task vehicles is less than a preset safe distance, the dispatching platform adjusts the correlation between the two local task paths. The vehicle spacing refers to a minimum spacing between contour lines of two task vehicles in a direction perpendicular to the driving direction of the two task vehicles. The vehicle spacing may be obtained via a predicted dynamic swept area, and more descriptions regarding a dynamic swept area may be found in the following description. The preset safe distance refers to a safe distance at which two task vehicles can safely pass each other or drive side-by-side, and the preset safe distance is set based on experience.

In some embodiments, an adjustment magnitude of the correlation between the different local task paths is positively correlated with the difference between the road width and the sum of widths of the two task vehicles and the preset threshold, or a difference between the vehicle spacing of the task vehicle and the preset safe distance.

In some embodiments of the present disclosure, using the similarity can ensure that the local optimization does not excessively deviate from the globally optimal path, thereby avoiding a problem of sacrificing overall efficiency for obstacle avoidance. By introducing the road width and the size information of the task vehicle to adjust the correlation, conflict prediction not only relies on the time difference but also relies on spatial tolerance, thereby solving a problem of misjudging potential conflicts in narrow road environments.

In some embodiments, a numerical value corresponding to the size information of the task vehicle is a dynamic value, and the size information is determined based on a dynamic swept area generated based on a current steering angle and a current articulation angle of the task vehicle.

The numerical value corresponding to the size information of the task vehicle, being the dynamic value, can be understood as follows. Different from a static rectangular bounding box (i.e., using a fixed rectangle to enclose an entire vehicle), a maximum projection area and an occupied width of a body and a trailer of an existing task vehicle on a ground may change when turning at a current moment and within a future predicted time step.

The steering angle refers to an included angle between an orientation of front wheels of the vehicle and an orientation of a front of the vehicle. In some embodiments, the steering angle may be obtained by reading real-time parameters (e.g., a count of rotations, an angle, etc., of a motor shaft) of a steering actuator via an encoder disposed on the steering actuator.

The articulation angle refers to an included angle between the front of the vehicle and the trailer. In some embodiments, the articulation angle may be obtained by an angle sensor disposed at an articulation point.

More descriptions regarding the definition of the dynamic swept area may be found in the above description. In some embodiments, the dynamic swept area takes an inner wheel difference and a tail swing effect of the task vehicle into account. In some embodiments, the dispatching platform may determine the dynamic swept area corresponding to each moment by using a preset model (e.g., an Ackermann steering geometry model or a dual-axle steering model) based on the real-time speed of the task vehicle, the steering angle, the articulation angle, and the vehicle posture. The vehicle posture may be obtained by constructing a driving model of the task vehicle and performing deduction.

In some implementations, the correlation between the different local task paths may also be determined by determining an overlapping area or a minimum boundary distance between predicted dynamic swept areas of the task vehicles on two local task paths at the same moment. The overlapping area of the dynamic swept areas is positively correlated with the correlation between the different local task paths, and a difference between the preset safety distance and the minimum boundary distance of the dynamic swept areas is positively correlated with the correlation between the different local task paths.

In some embodiments of the present disclosure, when an articulated truck turns, a trailer part of the articulated truck shifts inward, so that an actual occupied road width is much smaller than a width of a static box. Therefore, using the static box overestimates a required space of the articulated truck, resulting in overly conservative dispatching and a waste of road resources. In addition, a precise model can predict an area that an inner side of the trailer may sweep during a narrow-road U-turn or a right-angle turn. Therefore, sufficient space can be reserved in advance to avoid a collision accident caused by missing the inner wheel difference.

In some embodiments, the correlation between the different local task paths is positively correlated with an occlusion degree of the perception fields of view between the task vehicles.

The occlusion degree of the perception fields of view is used to quantify an influence degree of a body size and a position of one task vehicle (an occluding vehicle) on the ability of sensors of another task vehicle (an occluded vehicle) to acquire information.

In some embodiments, the dispatching platform constructs a perception field of view model, predicts the task vehicles on the two local task paths based on the perception field of view model, and then determines the occlusion degree of the perception fields of view for a key observation area.

The perception field of view model refers to a geometric model composed of an effective coverage area and a blind spot of sensors (e.g., a forward light detection and ranging (LiDAR), a side camera, etc.) deployed on the task vehicle. In some embodiments, the perception field of view model may be constructed by introducing parameters of the sensors, simulating an environment (e.g., the length, the width, the road curvature, the road gradient, etc., of a road) on the local task path, and parameters of the local task path.

The key observation area refers to an area on the local task path that is crucial for a safety decision of the task vehicle. Merely by way of example, the key observation area may include an intersection blind spot, a gathering area of a plurality of task vehicles, a sidewalk, or the like.

In some embodiments, in the perception field of view model, the dispatching platform may emit simulated perception rays from positions of the sensors of a task vehicle (i.e., the occluded vehicle) toward the key observation area and track the simulated perception rays. If partial simulated perception rays are blocked by another task vehicle (i.e., the occluding vehicle) at a predicted position (i.e., a predicted position where the task vehicle arrives at this moment), the dispatching platform determines a ratio of a count of blocked simulated perception rays to a total count of simulated perception rays, and uses the ratio as the occlusion degree of the perception fields of view of the task vehicle.

In some embodiments, if the occlusion degree exceeds a preset occlusion threshold, the dispatching platform increases the correlation between different local task paths corresponding to the occluded vehicle and the occluding vehicle. An increase magnitude of the correlation between the different local task paths is positively correlated with a difference between the occlusion degree and the preset occlusion threshold. The preset occlusion threshold is set based on experience.

In some embodiments of the present disclosure, setting the correlation between the different local task paths to be positively correlated with the occlusion degree of the perception fields of view between the task vehicles enables an optimization algorithm to actively select a traffic passing strategy that maximizes the overall perception field of view of the fleet. For example, if a preceding vehicle blocks a sight line of a following vehicle at an intersection, the system instructs the preceding vehicle to pass in advance or extends a waiting time to avoid the following vehicle from causing congestion for performing emergency braking due to a lack of perception information. Such a setting can elevate dispatching of the unmanned vehicle fleet to an information-sharing level, thereby achieving an upgrade from physical collision avoidance to perception coordination.

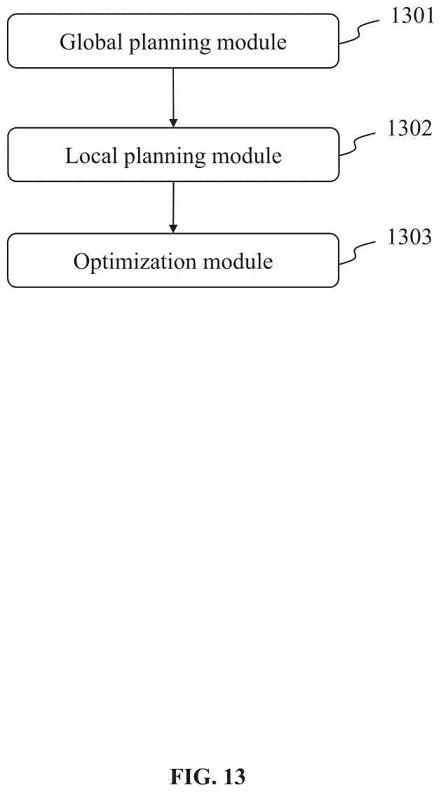

Embodiments of the present disclosure further provide an apparatus for dispatching an unmanned vehicle fleet corresponding to the method for dispatching the unmanned vehicle fleet. FIG. 13 is a schematic diagram illustrating a structure of an apparatus for dispatching an unmanned vehicle fleet according to some embodiments of the present disclosure. As shown in FIG. 13, the apparatus for dispatching the unmanned vehicle fleet includes a global planning module 1301, a local planning module 1302, and an optimization module 1303. In some embodiments, a dispatching platform may be integrated into the apparatus for dispatching the unmanned vehicle, and the global planning module 1301, the local planning module 1302, and the optimization module 1303 may be sub-modules through which the dispatching platform implements corresponding functions.

The global planning module 1301 is configured to acquire a global path planning result by performing global path planning on the unmanned vehicle fleet in a target area. The global path planning result includes a global task path of a task vehicle in the unmanned vehicle fleet.

The local planning module 1302 is configured to determine a local task path of the task vehicle based on driving information corresponding to the task vehicle and reference information corresponding to the global task path.

The optimization module 1303 is configured to generate optimized local task path information by optimizing the local task path based on attribute information of the local task path.

In some embodiments, when performing the global path planning on the unmanned vehicle fleet in the target area, in response to a newly added task, the global planning module 1301 may determine a newly added vehicle in the unmanned vehicle fleet; determine a starting point and a destination point of the newly added vehicle based on the newly added task; and acquire the global path planning result by performing the global path planning based on existing task paths of existing task vehicles in the unmanned vehicle fleet and the starting point and the destination point of the newly added vehicle.

In some embodiments, when performing the global path planning on the unmanned vehicle fleet in the target area, the global planning module 1301 may construct a directed road network graph corresponding to the target area; and acquire the global path planning result by performing the global path planning based on the directed road network graph and a starting point and a destination point of the task vehicle.

In some embodiments, when determining the local task path of the task vehicle, the local planning module 1302 may determine a trajectory of the local task path based on obstacle information and traffic rule information; determine a speed of the local task path based on a speed parameter; and determine a length of the local task path based on a safety parameter and the speed parameter.

In some embodiments, when optimizing the local task path, the optimization module 1303 may optimize the local task path based on the attribute information and an objective function. The objective function is determined based on a similarity between the local task path before optimization and the local task path after optimization, and a correlation between different local task paths, and the correlation reflects a collision probability of task vehicles corresponding to the different local task paths.

In some embodiments, the apparatus for dispatching the unmanned vehicle fleet may further include a correlation determination module (not shown in the drawings). The correlation determination module is configured to determine a time difference for the task vehicles corresponding to the different local task paths to arrive at a path intersection point based on the attribute information corresponding to the different local task paths, and determine the correlation between the different local task paths based on the time difference.

In some embodiments, the optimized local task path information comprises at least one of an optimized local task path or a traffic passing strategy of the task vehicle corresponding to the local task path.

In some embodiments, the apparatus for dispatching the unmanned vehicle fleet may further include a control module (not shown in the drawings). The control module is configured to generate a control instruction based on the optimized local task path information and drive a steering actuator, a power system, and a braking system of the task vehicle to operate based on the control instruction, so that the task vehicle travels according to an optimized local task path.

In some embodiments, when performing the global path planning, the global planning module 1301 may also dynamically adjust the weight of the edge of the directed road network graph based on a historical passing time of the road, a road curvature, or a real-time traffic density. The intersection capacity is determined based on a statistical value of a vehicle flow in the target area, and the vehicle flow is collected by an acquisition device deployed in the target area.

In some embodiments, the apparatus for dispatching the unmanned vehicle fleet may further include a parameter confirmation module (not shown in the drawings). The parameter confirmation module is configured to determine dynamic characteristics of the task vehicle through a vehicle dynamics model based on a real-time load of the task vehicle, a center-of-gravity position of the task vehicle, a road gradient of the local task path corresponding to the task vehicle, and an adhesion coefficient between a tire and a road surface, wherein the vehicle dynamics model is a machine learning model; determine a maximum recommended speed based on the dynamic characteristics; determine a maximum allowable speed based on a maximum road speed limit, a historical maximum road speed, a maximum safe speed corresponding to a task/vehicle type, a system limit speed of the task vehicle, and the maximum recommended speed; and limit the speed of the local task path to not exceed the maximum allowable speed.

In some embodiments, the control module may also generate a speed limiting instruction based on the maximum allowable speed; control a speed limiter of the task vehicle to operate based on the speed limiting instruction; and in response to a real-time speed of the task vehicle exceeding the maximum allowable speed, reduce the real-time speed of the task vehicle by the speed limiter. The correlation between different local task paths is determined based on the road width of the local task paths or the dimension information of the task vehicles.

In some embodiments, the apparatus for dispatching the unmanned vehicle fleet may further include a similarity confirmation module (not shown in the drawings). The similarity confirmation module is configured to determine the similarity between the local task path before optimization and the local task path after optimization based on at least one of a speed deviation, a curvature deviation, or a path offset distance between the local task path before optimization and the local task path after optimization. The correlation confirmation module is further configured to adjust the correlation between the different local task paths based on a road width of the local task path or size information of the task vehicle.

In some embodiments, a numerical value corresponding to the size information of the task vehicle is a dynamic value, and the size information is determined based on a dynamic swept area generated based on a current steering angle and a current articulation angle of the task vehicle.

In some embodiments, the correlation between the different local task paths is positively correlated with an occlusion degree of the perception fields of view between the task vehicles.

Specific details may be found in other parts of the present disclosure, which are not repeated here.

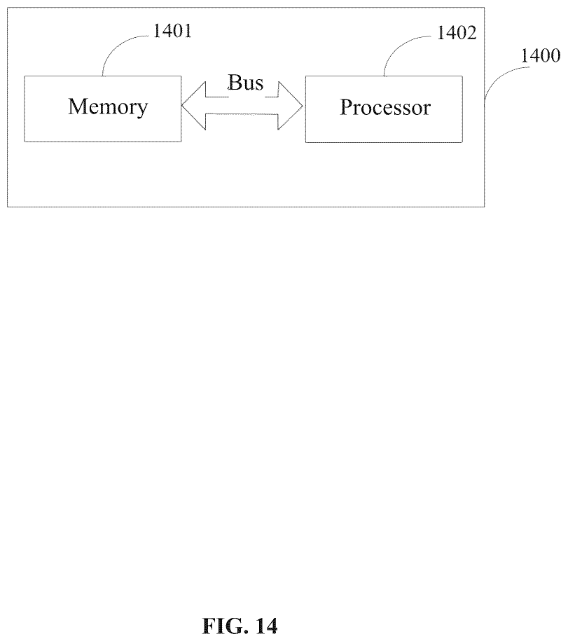

Embodiments of the present disclosure further provide an electronic device corresponding to the method for dispatching the unmanned vehicle fleet. FIG. 14 is a schematic diagram illustrating a structure of an electronic device according to some embodiments of the present disclosure. As shown in FIG. 14, the electronic device 1400 includes a processor 1402, a memory 1401, and a bus. The memory 1401 stores machine-readable instructions executable by the processor 1402, and when the electronic device 1400 runs, the processor 1402 communicates with the memory 1401 through the bus, and the machine-readable instructions, when executed by the processor 1402, cause the processor 1402 to perform operations of the method for dispatching the unmanned vehicle fleet described in the present disclosure.

Embodiments of the present disclosure further provide a computer-readable storage medium corresponding to the method for dispatching the unmanned vehicle fleet. The computer-readable storage medium stores a computer program, and the computer program, when executed by a processor, causes the processor to perform operations of the method for dispatching the unmanned vehicle fleet in the present disclosure.

Those skilled in the art may clearly understand that, for convenience and brevity of description, specific working processes of the described systems and apparatuses may refer to corresponding processes in the method embodiments. More descriptions are not repeated in the present disclosure. In the several embodiments provided in the present disclosure, it should be understood that the disclosed systems, apparatuses, and methods may be implemented in other manners. The described apparatus embodiments are merely illustrative. Merely by way of example, the division of modules is merely a logical function division. In actual implementation, other division manners may exist. As another example, a plurality of modules or components may be combined or integrated into another system, or some features may be omitted or not executed. In addition, the displayed or discussed mutual couplings or direct couplings or communication connections may be indirect couplings or communication connections through some communication interfaces, apparatuses, or modules. The couplings or communication connections may be electrical, mechanical, or in other forms.

Modules described as separate components may or may not be physically separate. Components displayed as modules may or may not be physical units. The components may be located in one place or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit.

When the functions are implemented in a form of a software functional unit and sold or used as an independent product, the functions may be stored in a processor-executable non-volatile computer-readable storage medium. Based on such an understanding, the technical solutions of the present disclosure, essentially, or the part contributing to the prior art, or part of the technical solutions, may be implemented in the form of a software product. The computer software product is stored in a storage medium and includes several instructions for instructing a computer device (which may be a personal computer, a platform server, a network device, etc.) to perform all or some of the operations of the methods in the embodiments of the present disclosure. The foregoing storage medium includes any medium that can store program code, such as a U disk, a removable hard disk, a read-only memory (ROM), a random access memory (RAM), a magnetic disk, or an optical disc.

The foregoing descriptions are merely specific implementations of the present disclosure. However, the protection scope of the present disclosure is not limited thereto. Any person skilled in the art can easily conceive of changes or replacements within the technical scope disclosed in the present disclosure. The changes or replacements shall fall within the protection scope of the present disclosure. Therefore, the protection scope of the present disclosure shall be subject to the protection scope of the claims.

What is claimed is:

1. A method for dispatching an unmanned vehicle fleet, comprising:
acquiring a global path planning result by performing global path planning on the unmanned vehicle fleet in a target area, wherein the global path planning result comprises a global task path of a task vehicle in the unmanned vehicle fleet;
determining a local task path of the task vehicle based on driving information corresponding to the task vehicle and reference information corresponding to the global task path; and
generating optimized local task path information by optimizing the local task path based on attribute information of the local task path.

2. The method according to claim 1, wherein the acquiring a global path planning result by performing global path planning on the unmanned vehicle fleet in a target area comprises:
in response to a newly added task, determining a newly added vehicle in the unmanned vehicle fleet;
determining a starting point and a destination point of the newly added vehicle based on the newly added task; and
acquiring the global path planning result by performing the global path planning based on existing task paths of existing task vehicles in the unmanned vehicle fleet and the starting point and the destination point of the newly added vehicle.

3. The method according to claim 1, wherein the acquiring a global path planning result by performing global path planning on the unmanned vehicle fleet in a target area comprises:
constructing a directed road network graph corresponding to the target area, wherein, in the directed road network graph, a node denotes an intersection, an edge denotes a road, and a weight of the edge is related to at least one of a road length or an intersection capacity; and
acquiring the global path planning result by performing the global path planning based on the directed road network graph and a starting point and a destination point of the task vehicle.

4. The method according to claim 1, wherein the determining a local task path of the task vehicle based on driving information corresponding to the task vehicle and reference information corresponding to the global task path comprises:
determining a trajectory of the local task path based on obstacle information and traffic rule information;
determining a speed of the local task path based on a speed parameter; and
determining a length of the local task path based on a safety parameter and the speed parameter.

5. The method according to claim 1, wherein the attribute information of the local task path comprises at least one of: a trajectory of the local task path, a speed of the local task path, a length of the local task path, a priority of the local task path, or obstacle information corresponding to the local task path.

6. The method according to claim 1, wherein the optimizing the local task path based on attribute information of the local task path comprises:
optimizing the local task path based on the attribute information and an objective function, wherein the objective function is determined based on a similarity between the local task path before optimization and the local task path after optimization and a correlation between different local task paths, and the correlation reflects a collision probability of task vehicles corresponding to the different local task paths.

7. The method according to claim 6, wherein the correlation between the different local task paths is determined by:
determining a time difference for the task vehicles corresponding to the different local task paths to arrive at a path intersection point based on the attribute information corresponding to the different local task paths; and
determining the correlation between the different local task paths based on the time difference.

8. The method according to claim 1, wherein the optimized local task path information comprises at least one of an optimized local task path or a traffic passing strategy of the task vehicle corresponding to the local task path.

9. The method according to claim 1, further comprising:
generating a control instruction based on the optimized local task path information; and
driving a steering actuator, a power system, and a braking system of the task vehicle to operate based on the control instruction, so that the task vehicle travels according to an optimized local task path.

10. The method according to claim 3, further comprising:
dynamically adjusting the weight of the edge of the directed road network graph based on a historical passing time of the road, a road curvature, or a real-time traffic density, wherein the intersection capacity is determined based on a statistical value of a vehicle flow in the target area, and the vehicle flow is collected by an acquisition device deployed in the target area.

11. The method according to claim 1, wherein a speed parameter in the reference information corresponding to the global task path is determined by:
determining dynamic characteristics of the task vehicle through a vehicle dynamics model based on a real-time load of the task vehicle, a center-of-gravity position of the task vehicle, a road gradient of the local task path corresponding to the task vehicle, and an adhesion coefficient between a tire and a road surface, wherein the vehicle dynamics model is a machine learning model;
determining a maximum recommended speed based on the dynamic characteristics;
determining a maximum allowable speed based on a maximum road speed limit, a historical maximum road speed, a maximum safe speed corresponding to a task/vehicle type, a system limit speed of the task vehicle, and the maximum recommended speed; and
limiting a speed of the local task path to not exceed the maximum allowable speed.

12. The method according to claim 11, further comprising:
generating a speed limiting instruction based on the maximum allowable speed;
controlling a speed limiter of the task vehicle to operate based on the speed limiting instruction; and
in response to a real-time speed of the task vehicle exceeding the maximum allowable speed, reducing the real-time speed of the task vehicle by the speed limiter.

13. The method according to claim 6, further comprising:
determining the similarity between the local task path before optimization and the local task path after optimization based on at least one of a speed deviation, a curvature deviation, or a path offset distance between the local task path before optimization and the local task path after optimization; and
adjusting the correlation between the different local task paths based on a road width of the local task path or size information of the task vehicle.

14. The method according to claim 13, wherein a numerical value corresponding to the size information of the task vehicle is a dynamic value, and the size information is determined based on a dynamic swept area generated based on a current steering angle and a current articulation angle of the task vehicle.

15. The method according to claim 14, wherein the correlation between the different local task paths is positively correlated with an occlusion degree of perception fields of view between the task vehicles.

16. An apparatus for dispatching an unmanned vehicle fleet, comprising:
a global planning module configured to acquire a global path planning result by performing global path planning on the unmanned vehicle fleet in a target area, wherein the global path planning result comprises a global task path of a task vehicle in the unmanned vehicle fleet;
a local planning module configured to determine a local task path of the task vehicle based on driving information corresponding to the task vehicle and reference information corresponding to the global task path; and
an optimization module configured to generate optimized local task path information by optimizing the local task path based on attribute information of the local task path.

17. An electronic device, comprising: a processor, a memory, and a bus, wherein the memory stores machine-readable instructions executable by the processor, and when the electronic device runs, the processor communicates with the memory through the bus, and the machine-readable instructions, when executed by the processor, cause the processor to perform a method for dispatching an unmanned vehicle fleet, wherein the method comprising:
acquiring a global path planning result by performing global path planning on the unmanned vehicle fleet in a target area, wherein the global path planning result comprises a global task path of a task vehicle in the unmanned vehicle fleet;
determining a local task path of the task vehicle based on driving information corresponding to the task vehicle and reference information corresponding to the global task path; and
generating optimized local task path information by optimizing the local task path based on attribute information of the local task path.
